(19) United States
(12) Patent Application Publication
(10) Pub. No.: US 2024/0177071 A1
(43) Pub. Date: May 30, 2024

(54) System, Method, and Computer Program Product to Compare Machine Learning Models

(71) Applicant: Visa International Service Association, San Francisco, CA (US)

(72) Inventors: Junpeng Wang, Santa Clara, CA (US); Liang Wang, San Jose, CA (US); Yan Zheng, Los Gatos, CA (US); Michael Yeh, Newark, CA (US); Shubham Jain, Mountain View, CA (US); Wei Zhang, Fremont, CA (US); Zhongfang Zhuang, San Jose, CA (US); Hao Yang, San Jose, CA (US)

(21) Appl. No.: 18/281,663

(22) PCT Filed: Mar. 30, 2022
(86) PCT No.: PCT/IB22/52974

§ 371 Date: Sep. 12, 2023

Related U.S. Application Data
(60) Provisional application No. 63/167,882, filed on Mar. 30, 2021.
(60) Provisional application No. 63/297,288, filed on Jan. 7, 2022.

(30) Foreign Application Priority Data
Sep. 22, 2021 (WO) PCT/US2021/051458

(51) Int. Cl. G06N 20/20; G06F 18/2415

(52) U.S. Cl. CPC G06N 20/20; G06F 18/2415

(57) ABSTRACT

Systems, methods, and computer program products may compare machine learning models by identifying data instances with disagreed predictions and learning from the disagreement. Based on a model interpretation technique, differences between the compared machine learning models may be interpreted. Multiple metrics to prioritize meta-features from different perspectives may also be provided.

### CROSS REFERENCE TO RELATED APPLICATIONS

This application is the United States national phase of International Application No. PCT/IB2022/052974 filed Mar. 30, 2022, and claims priority to U.S. Provisional Patent Application No. 63/167,882, filed Mar. 30, 2021, U.S. Provisional Patent Application No. 63/297,288, filed Jan. 7, 2022, and International Patent Application No. PCT/US21/51458, filed Sep. 22, 2021, the entire disclosures of which are incorporated herein by reference.

### BACKGROUND

### 1. Technical Field

This disclosure relates generally to machine learning models and, in some non-limiting embodiments or aspects, to systems, methods, and computer program products for comparing the accuracy of machine learning models.

### 2. Technical Considerations

Classification (e.g., predicting a likelihood of given data instances to be different categories, etc.) is a fundamental problem in machine learning (ML). Numerous classification models have been proposed for this problem, including traditional models (e.g., support vector machines (SVMs), naïve Bayes classifiers, etc.), ensemble learning models (e.g., random forest models, tree boosting models, etc.), and deep learning models (e.g., convolution neural networks (CNNs), recurrent neural networks (RNNs), etc.). The outstanding performance of these classifiers has made them widely adopted in many real-world applications, such as spam filtering, click-through rate (CTR) predictions for advertising, and object recognition for autonomous driving. A small improvement of these models can bring significant revenue growth for companies in the corresponding fields. As a result, a fast-growing number of classifiers is being produced every day. Accordingly, comparing classifiers and identifying the best one to use become an increasingly more important problem.

Interpreting classification models is attracting increasingly more attention in recent years and numerous solutions have been proposed. Roughly, model interpretations can be categorized into model-specific interpretations and model-agnostic interpretations. Model-specific interpretations consider classification models as “white-boxes”, where people have access to all internal details. For example, most interpretations for deep learning models visualize and investigate the internal neurons' activation to disclose how data were transformed internally. Model-agnostic interpretations regard predictive models as “black-boxes”, where only the models' input and output are available. These approaches often employ an interpretable surrogate model to mimic or probe the behavior of the interpreted models locally or globally. For example, Local Interpretable Model-Agnostic Explanation (LIME) uses a linear model as a surrogate to simulate the local behavior of the more complicated classifier to be interpreted. Deep Visual Interpretation and Diagnosis for Image Classifiers via Knowledge Distillation (DeepVID) trains an interpretable model using the knowledge distilled from the original classifier for interpretation. RuleMatrix converts classification models as a set of standardized IF-THEN-ELSE rules using only the models' input-output behaviors. A common goal for both groups of interpretation solutions is to answer the question “What input features are more important to the models' output?”. There are also solutions to statistically quantify features' importance.

Two classifiers can be compared from various perspectives using different numerical metrics (e.g., accuracy, precision, LogLoss, etc.), which may help to select models with an overall better performance. Multiple model-agnostic visualization and comparison solutions have been proposed based on these metrics because generating these metrics does not need to open the “black-box” of different classifiers. However, as these existing solutions do not touch the backbone of different classifiers, they often fail to reveal where a classifier may outperform other classifiers. Additionally, few details are provided to help model designers relate the performance discrepancy with the dissimilar working mechanisms of individual classifiers. For example, many model-building and visualization toolkits, such as Tensor-Flow® and scikit-learn, provide built-in application programming interfaces (APIs) for these numerical metrics. However, these aggregated metrics often fall short to provide sufficient details in model comparison and selection. For example, two models may achieve the same accuracy in very different ways and the underlying details are often of more interest when comparing the models.

Many visual analytics works have tried to go beyond these aggregated metrics for more comprehensive model comparisons. For example, Manifold® compares two models by disclosing the agreed and disagreed predictions. The comparison is model-agnostic, and for user-selected instances, Manifold® can identify the features contributing to the prediction discrepancy between the models. DeepCompare compares deep learning models with incomparable architectures (e.g., CNN vs RNN, etc.) through their activation patterns. CNNComparator compares the same CNN from different training stages to reveal the model's evolution. Deconvolution techniques have also been adapted to compare CNNs. These existing comparison works mostly rely on humans' visual comprehension to identify models' behavior differences.

Feature visualization in ML may focus either on (1) revealing what features have been captured by predictive models or (2) prioritizing features based on their impact magnitude or importance to limit the scope of analysis. The former is often conducted on image data and may use “visualization by optimization” to produce feature maps that activate different neurons to interpret deep learning models. Different saliency-map generation algorithms also share the same goal of highlighting the captured features to better understand deep neural networks. The latter focus of feature prioritization is often conducted on tabular data, where different metrics are used to order the contributions of different data features. For example, when interpreting tree-based models, the number of times that each feature is used to split a tree node is often used to rank the features. Local interpretable model-agnostic explanations (LIME) and SHapley Additive exPlanations (SHAP) also provide quantitative metrics to order different data features.

Replacing an old production model with a new model often comes with significant business impacts. To lower the risk, the new model is often initially launched in “shadow mode” (e.g., by deploying the model into production but collecting its output merely for analysis, etc.), during which the outputs from each of the old and new models is collected. “Swap analysis” may then be conducted to investigate whether the old model should be replaced/swapped with the new model by comparing the two models and disclosing their respective strengths and weaknesses. As very limited information is available during the swap analysis, model-agnostic comparisons may be more preferred.

Existing model comparisons may be limited to numerical metrics. For binary classifiers, an area under the receiver operating characteristic (ROC) curve (AUC) is a popular metric that profiles a classifiers true-positive rate (TPR) against a false-positive rate (FPR) across all classification thresholds. A larger AUC may be the indication of a better model (e.g., the model achieves higher TPRs with the cost of lower FPRs (correctly captured more with the cost of fewer mis-captures), etc.). Real applications may require a small FPR, as a result, the lower-left corner of the ROC may be more relevant, rather than the overall AUC value. For example, spam filtering applications cannot filter all emails to claim they capture all spam. Instead, the FPR should be small to keep the email system running. For example, in FIG. 6B, model M₁ may be better than model M₂, though the overall AUC of M₁ is apparently smaller.

However, AUC cannot tell in what conditions one model outperforms the other, which may be a desired question for model selection. Often, ML practitioners interpret the superior performance between models according to their understanding of the models. For example, RNNs may often outperform tree-based models, when the data present strong sequential behaviors. However, these general interpretations are usually supported with little evidence and there are few methods to generate any evidence.

### SUMMARY

Accordingly, provided are improved systems, devices, products, apparatus, and/or methods to compare machine learning models.

According to some non-limiting embodiments or aspects, provided is a system for comparing machine learning models, the system including: at least one processor programmed or configured to: receive a dataset of data instances, wherein each data instance includes a feature value for each feature of a plurality of features; generate outputs of a first machine learning model and outputs of a second machine learning model based on the dataset of data instances; determine a first subset of the outputs of the first machine learning model and a second subset of outputs of the second machine learning model; generate a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfy a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfy the first condition; generate a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition; train a first classifier based on the first true label matrix; train a second classifier based on the second true label matrix; and determine an accuracy of the first machine learning model and an accuracy of the second machine learning model based on the first classifier and the second classifier.

In some non-limiting embodiments or aspects, the first subset of the outputs of the first machine learning model and the second subset of outputs of the second machine learning model have a same number of values.

In some non-limiting embodiments or aspects, when determining the accuracy of the first machine learning model and the accuracy of the second machine learning model, the at least one processor is programmed or configured to: determine the accuracy of the first machine learning model and the accuracy of the second machine learning model based on a model interpretation technique that is performed on the first classifier and the second classifier.

In some non-limiting embodiments or aspects, the model interpretation technique is a model interpretation technique that involves Shapley additive explanations (SHAP) values.

In some non-limiting embodiments or aspects, when determining the accuracy of the first machine learning model and the accuracy of the second machine learning model, the at least one processor is programmed or configured to: calculate a SHAP value for each feature value of each data instance of the dataset for the first classifier; and calculate a SHAP value for each feature value of each data instance of the dataset for the second classifier.

In some non-limiting embodiments or aspects, when determining the accuracy of the first machine learning model and the accuracy of the second machine learning model, the at least one processor is programmed or configured to: generate a plot of the SHAP value for each feature value of each data instance of the dataset for the first classifier and the SHAP value for each feature value of each data instance of the dataset for the second classifier.

In some non-limiting embodiments or aspects, when determining the accuracy of the first machine learning model and the accuracy of the second machine learning model, the at least one processor is programmed or configured to: generate a plot of a plurality of SHAP values for a plurality of feature values of a first feature of each data instance of the dataset for the first classifier and a plurality of SHAP values for a plurality of feature values of the first feature of each data instance of the dataset for the second classifier.

In some non-limiting embodiments or aspects, when determining the accuracy of the first machine learning model and the accuracy of the second machine learning model, the at least one processor is programmed or configured to: calculate an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and calculate an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, wherein the accuracy metric comprises a metric associated with a measure of magnitude of a feature, a metric associated with a measure of consistency of a feature, a metric associated with a measure of contrast of a feature, or a metric associated with a measure of correlation of a feature.

According to some non-limiting embodiments or aspects, provided is a computer-implemented method, including: receiving, with at least one processor, a dataset of data instances, wherein each data instance comprises a feature value for each feature of a plurality of features; generating, with the at least one processor, outputs of a first machine learning model and outputs of a second machine learning model based on the dataset of data instances; determining, with the at least one processor, a first subset of the outputs of the first machine learning model and a second subset of outputs of the second machine learning model; generating, with the at least one processor, a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfy a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfy the first condition; generating, with the at least one processor, a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition; training, with the at least one processor, a first classifier based on the first true label matrix; training, with the at least one processor, a second classifier based on the second true label matrix; and determining, with the at least one processor, an accuracy of the first machine learning model and an accuracy of the second machine learning model based on the first classifier and the second classifier.

In some non-limiting embodiments or aspects, the first subset of the outputs of the first machine learning model and the second subset of outputs of the second machine learning model have a same number of values.

In some non-limiting embodiments or aspects, determining the accuracy of the first machine learning model and the accuracy of the second machine learning model includes: determining the accuracy of the first machine learning model and the accuracy of the second machine learning model based on a model interpretation technique that is performed on the first classifier and the second classifier.

In some non-limiting embodiments or aspects, the model interpretation technique is a model interpretation technique that involves Shapley additive explanations (SHAP) values.

In some non-limiting embodiments or aspects, determining the accuracy of the first machine learning model and the accuracy of the second machine learning model includes: calculating a SHAP value for each feature value of each data instance of the dataset for the first classifier; and calculating a SHAP value for each feature value of each data instance of the dataset for the second classifier.

In some non-limiting embodiments or aspects, determining the accuracy of the first machine learning model and the accuracy of the second machine learning model includes: generating a plot of the SHAP value for each feature value of each data instance of the dataset for the first classifier and the SHAP value for each feature value of each data instance of the dataset for the second classifier.

In some non-limiting embodiments or aspects, determining the accuracy of the first machine learning model and the accuracy of the second machine learning model includes: generating a plot of a plurality of SHAP values for a plurality of feature values of a first feature of each data instance of the dataset for the first classifier and a plurality of SHAP values for a plurality of feature values of the first feature of each data instance of the dataset for the second classifier.

In some non-limiting embodiments or aspects, determining the accuracy of the first machine learning model and the accuracy of the second machine learning model includes: calculating an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and calculating an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, wherein the accuracy metric comprises a metric associated with a measure of magnitude of a feature, a metric associated with a measure of consistency of a feature, a metric associated with a measure of contrast of a feature, or a metric associated with a measure of correlation of a feature.

According to some non-limiting embodiments or aspects, provided is a computer program product comprising at least one non-transitory computer-readable medium including program instructions that, when executed by at least one processor, cause the at least one processor to: receive a dataset of data instances, wherein each data instance comprises a feature value for each feature of a plurality of features; generate outputs of a first machine learning model and outputs of a second machine learning model based on the dataset of data instances; determine a first subset of the outputs of the first machine learning model and a second subset of outputs of the second machine learning model; generate a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfy a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfy the first condition; generate a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition; train a first classifier based on the first true label matrix; train a second classifier based on the second true label matrix; and determine an accuracy of the first machine learning model and an accuracy of the second machine learning model based on the first classifier and the second classifier.

In some non-limiting embodiments or aspects, the first subset of the outputs of the first machine learning model and the second subset of outputs of the second machine learning model have a same number of values.

In some non-limiting embodiments or aspects, determining the accuracy of the first machine learning model and the accuracy of the second machine learning model includes: determining the accuracy of the first machine learning model and the accuracy of the second machine learning model based on a model interpretation technique that is performed on the first classifier and the second classifier, wherein the model interpretation technique is a model interpretation technique that involves Shapley additive explanations (SHAP) values, and wherein determining the accuracy of the first machine learning model and the accuracy of the second machine learning model includes: calculating a SHAP value for each feature value of each data instance of the dataset for the first classifier; and calculating a SHAP value for each feature value of each data instance of the dataset for the second classifier.

In some non-limiting embodiments or aspects, determining the accuracy of the first machine learning model and the accuracy of the second machine learning model includes: generating a plot of the SHAP value for each feature value of each data instance of the dataset for the first classifier and the SHAP value for each feature value of each data instance of the dataset for the second classifier.

In some non-limiting embodiments or aspects, determining the accuracy of the first machine learning model and the accuracy of the second machine learning model includes: generating a plot of a plurality of SHAP values for a plurality of feature values of a first feature of each data instance of the dataset for the first classifier and a plurality of SHAP values for a plurality of feature values of the first feature of each data instance of the dataset for the second classifier.

In some non-limiting embodiments or aspects, determining the accuracy of the first machine learning model and the accuracy of the second machine learning model includes: calculating an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and calculating an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, wherein the accuracy metric comprises a metric associated with a measure of magnitude of a feature, a metric associated with a measure of consistency of a feature, a metric associated with a measure of contrast of a feature, or a metric associated with a measure of correlation of a feature.

According to some non-limiting embodiments or aspects, provided is a computer-implemented method, including: obtaining, with at least one processor, a plurality of features associated with a plurality of samples and a plurality of labels for the plurality of samples; generating, with the at least one processor, a plurality of first predictions for the plurality of samples by providing, as input to a first machine learning model, a first subset of features of the plurality of features, and receiving, as output from the first machine learning model, the plurality of first predictions for the plurality of samples; generating, with the at least one processor, a plurality of second predictions for the plurality of samples by providing, as input to a second machine learning model, a second subset of features of the plurality of features, and receiving, as output from the second machine learning model, the plurality of second predictions for the plurality of samples; generating, with the at least one processor, based on the plurality of first predictions, the plurality of second predictions, the plurality of labels, and a plurality of groups of samples of the plurality of samples; determining, with the at least one processor, based on the plurality of groups of samples, a first success rate associated with the first machine learning model and a second success rate associated with the second machine learning model; and identifying, with the at least one processor, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In some non-limiting embodiments or aspects, at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

In some non-limiting embodiments or aspects, the first subset of features is different than the second subset of features, and identifying the weak point in the second machine learning model further includes: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

In some non-limiting embodiments or aspects, a first set of hyperparameters for a machine learning algorithm used to generate the first machine learning model is different than a second set of hyperparameters for a same machine learning algorithm used to generate the second machine learning model, and wherein identifying the weak point in the second machine learning model further includes: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

In some non-limiting embodiments or aspects, the plurality of first predictions include a plurality of first prediction scores, wherein the plurality of second predictions include a plurality of second prediction scores, and generating the plurality of groups of samples of the plurality of samples further includes: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

In some non-limiting embodiments or aspects, aligning the plurality of second prediction scores to the same scale as the plurality of first prediction scores includes: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

In some non-limiting embodiments or aspects, generating the plurality of groups of samples of the plurality of samples includes: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the first success rate associated with the first machine learning model and the second success rate associated with the second machine learning model are determined according to the following Equations:

$$\begin{matrix}First Success Rate = \frac{X 1 + Z 1 + λ ( Z 2 )}{X 1 + Y 1 + Z 1 + λ ( X 2 + Y 2 + Z 2 )} \\ Second Success Rate = \frac{X 1 + Y 1 + λ ( Y 2 )}{X 1 + Y 1 + Z 1 + λ ( X 2 + Y 2 + Z 2 )}\end{matrix}$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

According to some non-limiting embodiments or aspects, provided is a system, including: at least one processor programmed and/or configured to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In some non-limiting embodiments or aspects, at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

In some non-limiting embodiments or aspects, the first subset of features is different than the second subset of features, and wherein the at least one processor is programmed and/or configured to identify the weak point in the second machine learning model by: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

In some non-limiting embodiments or aspects, a first set of hyperparameters for a machine learning algorithm used to generate the first machine learning model is different than a second set of hyperparameters for a same machine learning algorithm used to generate the second machine learning model, and wherein the at least one processor is programmed and/or configured to identify the weak point in the second machine learning model further by: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

In some non-limiting embodiments or aspects, the plurality of first predictions include a plurality of first prediction scores, wherein the plurality of second predictions include a plurality of second prediction scores, and wherein the at least one processor is programmed and/or configured to generate the plurality of groups of samples of the plurality of samples further by: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

In some non-limiting embodiments or aspects, the at least one processor is programmed and/or configured to align the plurality of second prediction scores to the same scale as the plurality of first prediction scores by: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

In some non-limiting embodiments or aspects, the at least one processor is programmed and/or configured to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the first success rate associated with the first machine learning model and the second success rate associated with the second machine learning model are determined according to the following Equations:

$$\begin{matrix}First Success Rate = \frac{X 1 + Z 1 + λ ( Z 2 )}{X 1 + Y 1 + Z 1 + λ ( X 2 + Y 2 + Z 2 )} \\ Second Success Rate = \frac{X 1 + Y 1 + λ ( Y 2 )}{X 1 + Y 1 + Z 1 + λ ( X 2 + Y 2 + Z 2 )}\end{matrix}$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

According to some non-limiting embodiments or aspects, provided is a computer program product comprising at least one non-transitory computer-readable medium including program instructions that, when executed by at least one processor, cause the at least one processor to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

In some non-limiting embodiments or aspects, at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

In some non-limiting embodiments or aspects, the instructions cause the at least one processor to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the first success rate associated with the first machine learning model and the second success rate associated with the second machine learning model are determined according to the following Equations:

$$\begin{matrix}First Success Rate = \frac{X 1 + Z 1 + λ ( Z 2 )}{X 1 + Y 1 + Z 1 + λ ( X 2 + Y 2 + Z 2 )} \\ Second Success Rate = \frac{X 1 + Y 1 + λ ( Y 2 )}{X 1 + Y 1 + Z 1 + λ ( X 2 + Y 2 + Z 2 )}\end{matrix}$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

Further non-limiting embodiments or aspects are set forth in the following numbered clauses:

Clause 1. A system for comparing machine learning models, the system comprising: at least one processor programmed or configured to: receive a dataset of data instances, wherein each data instance comprises a feature value for each feature of a plurality of features; generate outputs of a first machine learning model and outputs of a second machine learning model based on the dataset of data instances; determine a first subset of the outputs of the first machine learning model and a second subset of outputs of the second machine learning model; generate a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfy a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfy the first condition; generate a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition; train a first classifier based on the first true label matrix; train a second classifier based on the second true label matrix; and determine an accuracy of the first machine learning model and an accuracy of the second machine learning model based on the first classifier and the second classifier.

Clause 2. The system of clause 1, wherein the first subset of the outputs of the first machine learning model and the second subset of outputs of the second machine learning model have a same number of values.

Clause 3. The system of clauses 1 or 2, wherein when determining the accuracy of the first machine learning model and the accuracy of the second machine learning model, the at least one processor is programmed or configured to: determine the accuracy of the first machine learning model and the accuracy of the second machine learning model based on a model interpretation technique that is performed on the first classifier and the second classifier.

Clause 4. The system of any of clauses 1-3, wherein the model interpretation technique is a model interpretation technique that involves Shapley additive explanations (SHAP) values.

Clause 5. The system of any of clauses 1-4, wherein when determining the accuracy of the first machine learning model and the accuracy of the second machine learning model, the at least one processor is programmed or configured to: calculate a SHAP value for each feature value of each data instance of the dataset for the first classifier; and calculate a SHAP value for each feature value of each data instance of the dataset for the second classifier.

Clause 6. The system of any of clauses 1-5, wherein when determining the accuracy of the first machine learning model and the accuracy of the second machine learning model, the at least one processor is programmed or configured to: generate a plot of the SHAP value for each feature value of each data instance of the dataset for the first classifier and the SHAP value for each feature value of each data instance of the dataset for the second classifier.

Clause 7. The system of any of clauses 1-6, wherein when determining the accuracy of the first machine learning model and the accuracy of the second machine learning model, the at least one processor is programmed or configured to: generate a plot of a plurality of SHAP values for a plurality of feature values of a first feature of each data instance of the dataset for the first classifier and a plurality of SHAP values for a plurality of feature values of the first feature of each data instance of the dataset for the second classifier.

Clause 8. The system of any of clauses 1-7, wherein when determining the accuracy of the first machine learning model and the accuracy of the second machine learning model, the at least one processor is programmed or configured to: calculate an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and calculate an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, wherein the accuracy metric comprises a metric associated with a measure of magnitude of a feature, a metric associated with a measure of consistency of a feature, a metric associated with a measure of contrast of a feature, or a metric associated with a measure of correlation of a feature.

Clause 9. A computer-implemented method, comprising: receiving, with at least one processor, a dataset of data instances, wherein each data instance comprises a feature value for each feature of a plurality of features; generating, with the at least one processor, outputs of a first machine learning model and outputs of a second machine learning model based on the dataset of data instances; determining, with the at least one processor, a first subset of the outputs of the first machine learning model and a second subset of outputs of the second machine learning model; generating, with the at least one processor, a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfy a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfy the first condition; generating, with the at least one processor, a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition; training, with the at least one processor, a first classifier based on the first true label matrix; training, with the at least one processor, a second classifier based on the second true label matrix; and determining, with the at least one processor, an accuracy of the first machine learning model and an accuracy of the second machine learning model based on the first classifier and the second classifier.

Clause 10. The computer-implemented method of clause 9, wherein the first subset of the outputs of the first machine learning model and the second subset of outputs of the second machine learning model have a same number of values.

Clause 11. The computer-implemented method of clauses 9 or 10, wherein determining the accuracy of the first machine learning model and the accuracy of the second machine learning model includes: determining the accuracy of the first machine learning model and the accuracy of the second machine learning model based on a model interpretation technique that is performed on the first classifier and the second classifier.

Clause 12. The computer-implemented method of any of clauses 9-11, wherein the model interpretation technique is a model interpretation technique that involves Shapley additive explanations (SHAP) values.

Clause 13. The computer-implemented method of any of clauses 9-12, wherein determining the accuracy of the first machine learning model and the accuracy of the second machine learning model includes: calculating a SHAP value for each feature value of each data instance of the dataset for the first classifier; and calculating a SHAP value for each feature value of each data instance of the dataset for the second classifier.

Clause 14. The computer-implemented method of any of clauses 9-13, wherein determining the accuracy of the first machine learning model and the accuracy of the second machine learning model includes: generating a plot of the SHAP value for each feature value of each data instance of the dataset for the first classifier and the SHAP value for each feature value of each data instance of the dataset for the second classifier.

Clause 15. The computer-implemented method of any of clauses 9-14, wherein determining the accuracy of the first machine learning model and the accuracy of the second machine learning model includes: generating a plot of a plurality of SHAP values for a plurality of feature values of a first feature of each data instance of the dataset for the first classifier and a plurality of SHAP values for a plurality of feature values of the first feature of each data instance of the dataset for the second classifier.

Clause 16. The computer-implemented method of any of clauses 9-15, wherein determining the accuracy of the first machine learning model and the accuracy of the second machine learning model includes: calculating an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and calculating an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, wherein the accuracy metric comprises a metric associated with a measure of magnitude of a feature, a metric associated with a measure of consistency of a feature, a metric associated with a measure of contrast of a feature, or a metric associated with a measure of correlation of a feature.

Clause 17. A computer program product comprising at least one non-transitory computer-readable medium including program instructions that, when executed by at least one processor, cause the at least one processor to: receive a dataset of data instances, wherein each data instance comprises a feature value for each feature of a plurality of features; generate outputs of a first machine learning model and outputs of a second machine learning model based on the dataset of data instances; determine a first subset of the outputs of the first machine learning model and a second subset of outputs of the second machine learning model; generate a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfy a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfy the first condition; generate a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition; train a first classifier based on the first true label matrix; train a second classifier based on the second true label matrix; and determine an accuracy of the first machine learning model and an accuracy of the second machine learning model based on the first classifier and the second classifier.

Clause 18. The computer program product of clause 17, wherein the first subset of the outputs of the first machine learning model and the second subset of outputs of the second machine learning model have a same number of values.

Clause 19. The computer program product of clauses 17 or 18, wherein determining the accuracy of the first machine learning model and the accuracy of the second machine learning model includes: determining the accuracy of the first machine learning model and the accuracy of the second machine learning model based on a model interpretation technique that is performed on the first classifier and the second classifier, wherein the model interpretation technique is a model interpretation technique that involves Shapley additive explanations (SHAP) values, and wherein determining the accuracy of the first machine learning model and the accuracy of the second machine learning model includes: calculating a SHAP value for each feature value of each data instance of the dataset for the first classifier; and calculating a SHAP value for each feature value of each data instance of the dataset for the second classifier.

Clause 20. The computer program product of any of clauses 17-19, wherein determining the accuracy of the first machine learning model and the accuracy of the second machine learning model includes: generating a plot of the SHAP value for each feature value of each data instance of the dataset for the first classifier and the SHAP value for each feature value of each data instance of the dataset for the second classifier.

Clause 21. The computer program product of any of clauses 17-20, wherein determining the accuracy of the first machine learning model and the accuracy of the second machine learning model includes: generating a plot of a plurality of SHAP values for a plurality of feature values of a first feature of each data instance of the dataset for the first classifier and a plurality of SHAP values for a plurality of feature values of the first feature of each data instance of the dataset for the second classifier.

Clause 22. The computer program product of any of clauses 17-21, wherein determining the accuracy of the first machine learning model and the accuracy of the second machine learning model includes: calculating an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and calculating an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, wherein the accuracy metric comprises a metric associated with a measure of magnitude of a feature, a metric associated with a measure of consistency of a feature, a metric associated with a measure of contrast of a feature, or a metric associated with a measure of correlation of a feature.

Clause 1b. A computer-implemented method, comprising: obtaining, with at least one processor, a plurality of features associated with a plurality of samples and a plurality of labels for the plurality of samples; generating, with the at least one processor, a plurality of first predictions for the plurality of samples by providing, as input to a first machine learning model, a first subset of features of the plurality of features, and receiving, as output from the first machine learning model, the plurality of first predictions for the plurality of samples; generating, with the at least one processor, a plurality of second predictions for the plurality of samples by providing, as input to a second machine learning model, a second subset of features of the plurality of features, and receiving, as output from the second machine learning model, the plurality of second predictions for the plurality of samples; generating, with the at least one processor, based on the plurality of first predictions, the plurality of second predictions, the plurality of labels, and a plurality of groups of samples of the plurality of samples; determining, with the at least one processor, based on the plurality of groups of samples, a first success rate associated with the first machine learning model and a second success rate associated with the second machine learning model; and identifying, with the at least one processor, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

Clause 2b. The computer-implemented method of clause 1b, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

Clause 3b. The computer-implemented method of clauses 1b or 2b, wherein the first subset of features is different than the second subset of features, and wherein identifying the weak point in the second machine learning model further includes: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

Clause 4b. The computer-implemented method of any of clauses 1b-3b, wherein a first set of hyperparameters for a machine learning algorithm used to generate the first machine learning model is different than a second set of hyperparameters for a same machine learning algorithm used to generate the second machine learning model, and wherein identifying the weak point in the second machine learning model further includes: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

Clause 5b. The computer-implemented method of any of clauses 1b-4b, wherein the plurality of first predictions include a plurality of first prediction scores, wherein the plurality of second predictions include a plurality of second prediction scores, and wherein generating the plurality of groups of samples of the plurality of samples further includes: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

Clause 6b. The computer-implemented method of any of clauses 1b-5b, wherein aligning the plurality of second prediction scores to the same scale as the plurality of first prediction scores includes: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

Clause 7b. The computer-implemented method of any of clauses 1b-6b, wherein generating the plurality of groups of samples of the plurality of samples includes: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

Clause 8b. The computer-implemented method of any of clauses 1b-7b, wherein the first success rate associated with the first machine learning model and the second success rate associated with the second machine learning model are determined according to the following Equations:

$$\begin{matrix}First Success Rate = \frac{X 1 + Z 1 + λ ( Z 2 )}{X 1 + Y 1 + Z 1 + λ ( X 2 + Y 2 + Z 2 )} \\ Second Success Rate = \frac{X 1 + Y 1 + λ ( Y 2 )}{X 1 + Y 1 + Z 1 + λ ( X 2 + Y 2 + Z 2 )}\end{matrix}$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

Clause 9b. A system, comprising: at least one processor programmed and/or configured to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

Clause 10b. The system of clause 9b, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

Clause 11b. The system of clauses 9b or 10b, wherein the first subset of features is different than the second subset of features, and wherein the at least one processor is programmed and/or configured to identify the weak point in the second machine learning model by: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second machine learning model.

Clause 12b. The system of any of clauses 9b-11b, wherein a first set of hyperparameters for a machine learning algorithm used to generate the first machine learning model is different than a second set of hyperparameters for a same machine learning algorithm used to generate the second machine learning model, and wherein the at least one processor is programmed and/or configured to identify the weak point in the second machine learning model further by: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second machine learning model.

Clause 13b. The system of any of clauses 9b-12b, wherein the plurality of first predictions include a plurality of first prediction scores, wherein the plurality of second predictions include a plurality of second prediction scores, and wherein the at least one processor is programmed and/or configured to generate the plurality of groups of samples of the plurality of samples further by: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples.

Clause 14b. The system of any of clauses 9b-13b, wherein the at least one processor is programmed and/or configured to align the plurality of second prediction scores to the same scale as the plurality of first prediction scores by: assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

Clause 15b. The system of any of clauses 9b-14b, wherein the at least one processor is programmed and/or configured to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

Clause 16b. The system of any of clauses 9b-15b, wherein the first success rate associated with the first machine learning model and the second success rate associated with the second machine learning model are determined according to the following Equations:

$$\begin{matrix}First Success Rate = \frac{X 1 + Z 1 + λ ( Z 2 )}{X 1 + Y 1 + Z 1 + λ ( X 2 + Y 2 + Z 2 )} \\ Second Success Rate = \frac{X 1 + Y 1 + λ ( Y 2 )}{X 1 + Y 1 + Z 1 + λ ( X 2 + Y 2 + Z 2 )}\end{matrix}$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

Clause 17b. A computer program product comprising at least one non-transitory computer-readable medium including program instructions that, when executed by at least one processor, cause the at least one processor to: obtain a plurality of features associated with a plurality of samples and a plurality of labels for the plurality of samples; generate a plurality of first predictions for the plurality of samples by providing, as input to a first machine learning model, a first subset of features of the plurality of features, and receiving, as output from the first machine learning model, the plurality of first predictions for the plurality of samples; generate a plurality of second predictions for the plurality of samples by providing, as input to a second machine learning model, a second subset of features of the plurality of features, and receiving, as output from the second machine learning model, the plurality of second predictions for the plurality of samples; generate, based on the plurality of first predictions, the plurality of second predictions, the plurality of labels, and a plurality of groups of samples of the plurality of samples; determine, based on the plurality of groups of samples, a first success rate associated with the first machine learning model and a second success rate associated with the second machine learning model; and identify, based on the first success rate and the second success rate, a weak point in the second machine learning model associated with a first portion of samples of the plurality of samples including a same first value for a same first feature of the plurality of features and for which the first success rate associated with the first machine learning model is different than the second success rate associated with the second machine learning model.

Clause 18b. The computer program product of clause 17b, wherein at least one of: (i) the first subset of features is different than the second subset of features; (ii) a first set of hyperparameters for a machine learning algorithm used to generate the first machine learning model is different than a second set of hyperparameters for a same machine learning algorithm used to generate the second machine learning model; (iii) a first machine learning algorithm used to generate the first machine learning model is different than a second machine learning algorithm used to generate the second machine learning model; and (iv) a first training data set used to train the first machine learning model is different than a second training data set used to train the second machine learning model.

Clause 19b. The computer program product of clauses 17b or 18b, wherein the instructions cause the at least one processor to generate the plurality of groups of samples of the plurality of samples by: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

Clause 20b. The computer program product of any of clauses 17b-19b, wherein the first success rate associated with the first machine learning model and the second success rate associated with the second machine learning model are determined according to the following Equations:

$$\begin{matrix}First Success Rate = \frac{X 1 + Z 1 + λ ( Z 2 )}{X 1 + Y 1 + Z 1 + λ ( X 2 + Y 2 + Z 2 )} \\ Second Success Rate = \frac{X 1 + Y 1 + λ ( Y 2 )}{X 1 + Y 1 + Z 1 + λ ( X 2 + Y 2 + Z 2 )}\end{matrix}$$

where X1 is a number of samples in the first group of samples, Y1 is a number of samples in the second group of samples, Z1 is a number of samples in the third group of samples, X2 is a number of samples in the fourth group of samples, Y2 is a number of samples in the fifth group of samples, Z2 is a number of samples in the sixth group of samples, and λ is a discount factor.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

The patent or application file contains at least one drawing executed in color. Copies of this patent or patent application publication with color drawings will be provided by the Office upon request and payment of the necessary fee.

Additional advantages and details of the present disclosure are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process to compare machine learning models;

FIG. 4 is a flow chart of an implementation of non-limiting embodiments or aspects of a process to compare machine learning models;

FIG. 5 is a diagram of an implementation of non-limiting embodiments or aspects of subsets of samples for calculating a performance metric;

FIGS. 6A and 6B are graphs illustrating an example evaluation of binary classifiers with an area-under-curve (AUC) metric;

FIG. 7 illustrates an example dataset and interpretation matrix for a spam classifier;

FIG. 8A illustrates non-limiting embodiments or aspects of a Disagreement Distribution View of a visual interface;

FIG. 8B illustrates non-limiting embodiments or aspects of a Feature View of a visual interface;

FIG. 9A illustrates non-limiting embodiments or aspects of a summary plot;

FIG. 9B illustrates non-limiting embodiments or aspects of a summary plot that resolves overplotting issues;

FIG. 10 illustrates non-limiting embodiments or aspects of a 2D histogram of feature and SHapley Additive exPlanations (SHAP) values;

FIG. 11 illustrates non-limiting embodiments or aspects of summary plots visualizing contributions of features;

FIG. 12 illustrates non-limiting embodiments or aspects of bubble plots visualizing contributions of features;

FIG. 13 is a table illustrating an example comparison of a Tree and RNN models and RNN and GNN models according to non-limiting embodiments or aspects;

FIG. 14 illustrates non-limiting embodiments or aspects of a Disagreement Distribution View of a visual interface;

FIG. 15 illustrates non-limiting embodiments or aspects of a Disagreement Distribution View of a visual interface;

FIG. 16 illustrates non-limiting embodiments or aspects of a visual interface for comparing models;

FIG. 17 illustrates non-limiting embodiments or aspects of different metrics used in ranking meta-features in a visual interface;

FIG. 18 is a table that shows a performance of individual and ensembled models;

FIG. 19 is a graph illustrating relative success rates for example models;

FIG. 20 is graph illustrating disagreements between example models;

FIG. 21 is a graph illustrating relative success rates between example models;

FIG. 22 is a graph illustrating disagreements between example models;

FIG. 23 is a graph illustrating relative success rates between example models; and

FIG. 24 is a graph illustrating disagreements between example models.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” where appropriate (e.g., as a triggering condition for operation of a function of device).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “user interface” or “graphical user interface” or “visualization” refers to a generated display, such as one or more graphical user interfaces (GUIs) with which a user may interact, either directly or indirectly (e.g., through a keyboard, mouse, touchscreen, etc.).

There are multiple existing solutions to the individual problems of model interpretation and model comparison. For interpretation, Local Interpretable Model-Agnostic Explanation (LIME) and SHapley Additive exPlanations (SHAP) are two well-known examples, which attribute a classifier's prediction output back to individual input features. For comparison, Manifold® uses likelihood scores from a pair of classifiers to reflect a level of agreement/disagreement between the classifiers. However, existing solutions fail to address and solve each of these problems simultaneously by comparatively interpreting multiple classifiers. For Example, considering the following scenario in a spam filtering application, where machine learning (ML) practitioners need to choose between two spam classifiers model A and model B, the ML practitioners, using LIME, may find the number of URLs (n_url) in an email is an important feature to model A. Similarly, n_url may also be an important feature to model B based on LIME's interpretations. Comparing A and B with different numerical metrics (e.g., accuracy, etc.), each model may show similar overall performance with small differences. If a new email with a large n_url value is received and the predictions from model A and model B are very different, which prediction should be trusted? As one can see here, the interpretation of individual models (e.g., LIME's output, etc.) does not help to compare and select models in this scenario, as n_url is an important feature to each of the models A and B. The small performance difference revealed by the numerical metrics may not be sufficient to choose between the models either.

Non-limiting embodiments or aspects of the present disclosure are directed to systems, methods, and computer program products for comparing ML models. In some non-limiting embodiments or aspects, a model comparison system may include at least one processor programmed or configured to receive a dataset of data instances, wherein each data instance comprises a feature value for each feature of a plurality of features, generate outputs of a first ML model and outputs of a second ML model based on the dataset, determine a first subset of the outputs of the first ML model and a second subset of outputs of the second ML model, generate a disagreement matrix that includes a first set of grouped outputs of the first ML model and the second ML model and a second set of grouped outputs of the first ML model and the second ML model, where the first set of grouped outputs comprises a plurality of outputs of the first ML model that satisfy a first condition and a plurality of outputs of the second ML model that does not satisfy the first condition and the second set of grouped outputs comprises a plurality of outputs of the first ML model that does not satisfy the first condition and a plurality of outputs of the second ML model that satisfy the first condition, generate a plurality of true label matrices based on true labels of the first set of grouped outputs and the second set of grouped outputs, where a first true label matrix includes true positive outputs of the plurality of outputs of the first ML model that satisfy the first condition and true positive outputs of the plurality of outputs of the second ML model that satisfy the first condition and a second true label matrix includes false positive outputs of the plurality of outputs of the first ML model that satisfy the first condition and false positive outputs of the plurality of outputs of the second ML model that satisfy the first condition, train a first classifier based on the first true label matrix, train a second classifier based on the second true label matrix, and determine an accuracy of the first ML model and an accuracy of the second ML model based on the first classifier and the second classifier. In some non-limiting embodiments or aspects, the first subset of the outputs of the first ML model and the second subset of outputs of the second ML model have a same number of values. In some non-limiting embodiments or aspects, when determining the accuracy of the first ML model and the accuracy of the second ML model, the at least one processor is programmed or configured to determine the accuracy of the first ML model and the accuracy of the second ML model based on a model interpretation technique that is performed on the first classifier and the second classifier. In some non-limiting embodiments or aspects, the model interpretation technique is a model interpretation technique that involves SHAP values. In some non-limiting embodiments or aspects, when determining the accuracy of the first ML model and the accuracy of the second ML model, the at least one processor is programmed or configured to calculate a SHAP value for each feature value of each data instance of the dataset for the first classifier and calculate a SHAP value for each feature value of each data instance of the dataset for the second classifier. In some non-limiting embodiments or aspects, when determining the accuracy of the first ML model and the accuracy of the second ML model, the at least one processor is programmed or configured to generate a plot of the SHAP value for each feature value of each data instance of the dataset for the first classifier and the SHAP value for each feature value of each data instance of the dataset for the second classifier. In some non-limiting embodiments or aspects, when determining the accuracy of the first ML model and the accuracy of the second ML model, the at least one processor is programmed or configured to generate a plot of a plurality of SHAP values for a plurality of feature values of a first feature of each data instance of the dataset for the first classifier and a plurality of SHAP values for a plurality of feature values of the first feature of each data instance of the dataset for the second classifier. In some non-limiting embodiments or aspects, when determining the accuracy of the first ML model and the accuracy of the second ML model, the at least one processor is programmed or configured to calculate an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier and calculate an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier, where the accuracy metric comprises a metric associated with a measure of magnitude of a feature, a metric associated with a measure of consistency of a feature, a metric associated with a measure of contrast of a feature, or a metric associated with a measure of correlation of a feature.

In this way, non-limiting embodiments or aspects of the present disclosure provide a solution for the above scenario by answering which classifier behaves relatively better (e.g., which classifier is more likely to capture spam, etc.) in what feature-value ranges (e.g., when n_url is large or satisfies a threshold value, etc.), which directly helps to select models and leads to a better way to combine two models. For example, if model A outperforms model B when n_url is larger and model B outperforms model A when n_url is small, one can take scores from A for emails with a large n_url and scores from B for emails with a small n_url to generate a superior ensemble model. For example, the ensemble model may be generated using feature-weighted linear stacking (FWLS), in which features with more dissimilar/complementary behaviors in the two compared models may better ensemble the two models. However, there is also no existing solution to prioritize features based on their behavior difference in two models.

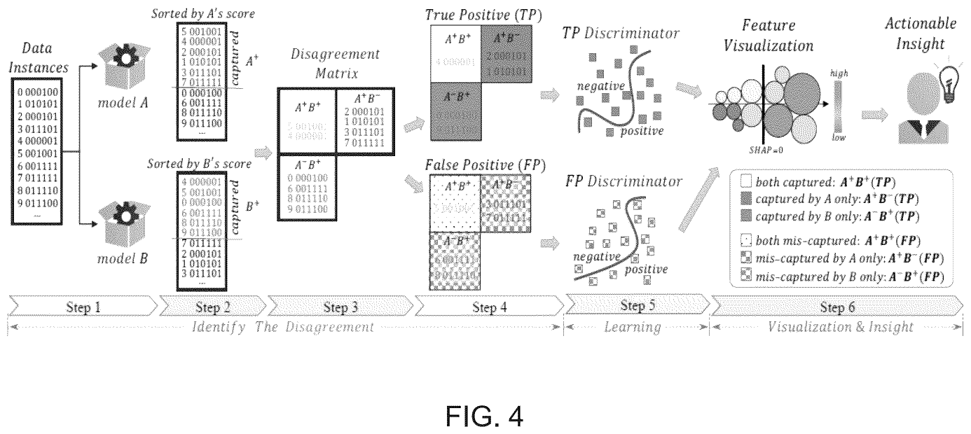

Non-limiting embodiments or aspects of the present disclosure provide a Learning-From-Disagreement (LFD) framework to comparatively interpret a pair of ML models (e.g., a pair of binary classifiers, etc.) by learning from a prediction disagreement between the ML models. For example, given a pair of binary classifiers A and B, the classifiers A and B may be used (e.g., as data filters, etc.) to construct a disagreement matrix, which identifies the instances captured (e.g., highly scored, etc.) by classifier A, but missed by classifier B (e.g., A⁺B⁻) and those instances captured by classifier B but missed by classifier A (e.g., A⁻B⁺). Instances captured by each of the classifiers A and B (e.g., A⁺B⁺) may be of less interest for the purpose of comparison. The true labels of these instances may further divide the disagreement matrix into two matrices for the true-positive (TP) and false-positive (FP), predictions respectively (e.g., Steps 1-4 in FIG. 4). Only the inputs and outputs of the compared classifiers may be used in LFD. For example, LFD may be model-agnostic (e.g., assume no knowledge of the models to be interpreted and compared, etc.). For each of the TP and FP sides, a discriminator model may be trained to differentiate A⁺B⁻ and A⁻B⁺ instances (e.g., the “learning” part, Step 5 in FIG. 4). In such an example, the discriminator may be any classification model, and the only constraint for the discriminator may be for it to be SHAP friendly so that it can be interpreted through SHAP to derive actionable insights (e.g., Step 6 in FIG. 4).

An issue when training the discriminator is that the data features used to train classifiers A and B may not be available during comparison. This may be a common case in industry, as model building and comparison may be conducted by different teams. Fortunately, as domain users may have prior knowledge on the compared classifiers, a set of new features (e.g., meta-features) may be used. For example, if one of the compared classifiers is a recurrent neural network (RNN), sequence-related features (e.g., sequence length, etc.) may be proposed to determine whether the RNN actually behaves better on instances with longer sequences. If one classifier is a graph neural network (GNN), neighbor-related features may be proposed. These meta-features make LFD agnostic the original model training features (e.g., feature-agnostic) and can probe the compared classifiers based on users' prior knowledge. Additionally, an impact or importance of meta-features from four different perspectives may be profiled through four metrics to prioritize features based on their behavior difference in the two models. These metrics may help to rank the meta-features and better identify the more complementary features to ensemble a pair of classifiers.

Accordingly, non-limiting embodiments or aspects of the present disclosure provide an LFD framework and facilitate the LFD framework with a visual feature analysis to comparatively interpret a pair of ML models and/or introduce metrics to prioritize or rank a large number of meta-features from different perspectives.

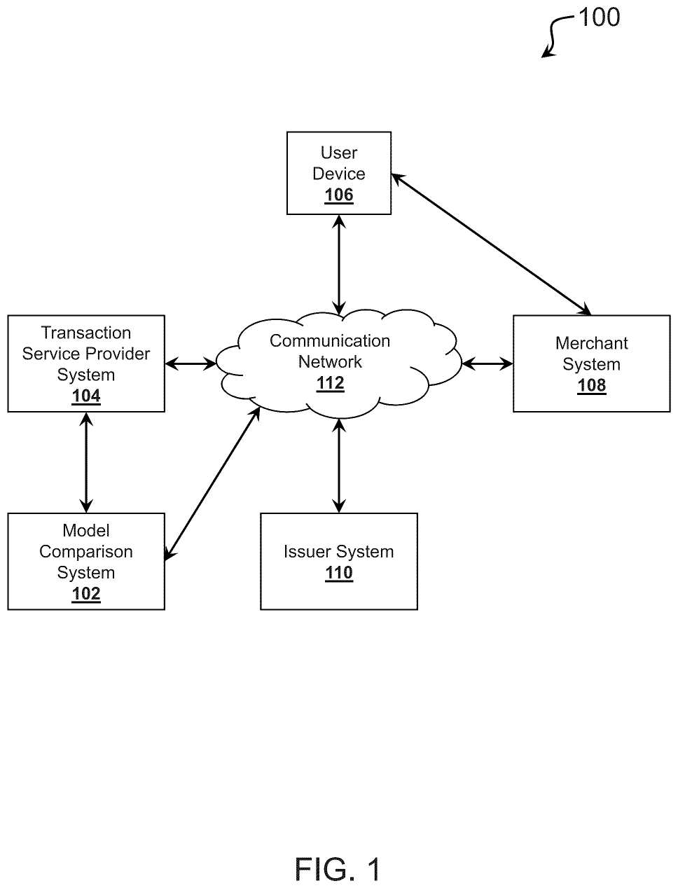

Referring now to FIG. 1, illustrated is a diagram of an example environment 100 in which devices, systems, methods, and/or products described herein may be implemented. As illustrated in FIG. 1, environment 100 includes model comparison system 102, transaction service provider system 104, user device 106, merchant system 108, issuer system 110, and communication network 112. Model comparison system 102, transaction service provider system 104, user device 106, merchant system 108, and issuer system 110 may interconnect (e.g., establish a connection to communicate and/or the like) via wired and wireless connections.

Model comparison system 102 may include one or more devices capable of being in communication with transaction service provider system 104, user device 106, merchant system 108, and issuer system 110 via communication network 112. For example, model comparison system 102 may include one or more computing devices, such as one or more desktop computers, laptop computers, servers, and/or like devices. In some non-limiting embodiments or aspects, model comparison system 102 may be associated with a transaction service provider and/or a payment gateway service provider, as described herein. For example, model comparison system 102 may be operated by a transaction service provider and/or a payment gateway service provider. In some non-limiting embodiments or aspects, model comparison system 102 may be a component of a transaction service provider system and/or a payment gateway service provider system.

Transaction service provider system 104 may include one or more devices capable of being in communication with model comparison system 102, user device 106, merchant system 108, and issuer system 110 via communication network 112. For example, transaction service provider system 104 may include one or more computing devices, such as one or more desktop computers, laptop computers, servers, and/or other like devices. In some non-limiting embodiments or aspects, transaction service provider system 104 may be associated with a transaction service provider and/or a payment gateway service provider, as described herein. For example, transaction service provider system 104 may be operated by a transaction service provider and/or a payment gateway service provider as described herein. In some non-limiting embodiments or aspects, model comparison system 102 may be a component of transaction service provider system 104.

User device 106 may include one or more devices capable of being in communication with model comparison system 102, transaction service provider system 104, merchant system 108, and issuer system 110 via communication network 112. For example, user device 106 may include one or more computing devices, such as one or more payment devices, one or more mobile devices (e.g., a smartphone, tablet, and/or the like), and/or other like devices. In some non-limiting embodiments or aspects, user device 106 may be associated with a user, as described herein.

Merchant system 108 may include one or more devices capable of being in communication with model comparison system 102, transaction service provider system 104, user device 106, and issuer system 110 via communication network 112. For example, merchant system 108 may include one or more computing devices, such as one or more POS devices, one or more POS systems, one or more servers, and/or other like devices. In some non-limiting embodiments or aspects, merchant system 108 may be associated with a merchant, as described herein.

Issuer system 110 may include one or more devices capable of being in communication with model comparison system 102, transaction service provider system 104, user device 106, and merchant system 108 via communication network 112. For example, issuer system 110 may include one or more computing devices, such as one or more desktop computers, laptop computers, servers, and/or like devices. In some non-limiting embodiments or aspects, issuer system 110 may be associated with an issuer, as described herein.

Communication network 112 may include one or more wired and/or wireless networks. For example, communication network 112 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

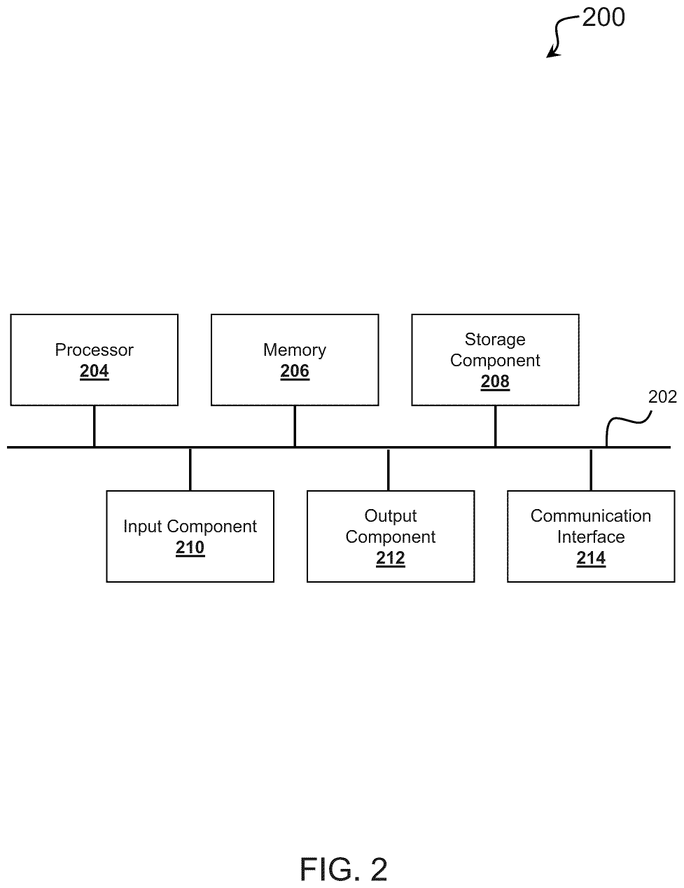

Referring now to FIG. 2, FIG. 2 is a diagram of example components of a device 200. Device 200 may correspond to model comparison system 102 (e.g., one or more devices of model comparison system 102), transaction service provider system 104 (e.g., one or more devices of transaction service provider system 104), user device 106, merchant system 108 (e.g., one or more devices of merchant system 108), and/or issuer system 110 (e.g., one or more devices of issuer system 110). In some non-limiting embodiments or aspects, model comparison system 102, transaction service provider system 104, user device 106, merchant system 108, and/or issuer system 110 may include at least one device 200 and/or at least one component of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

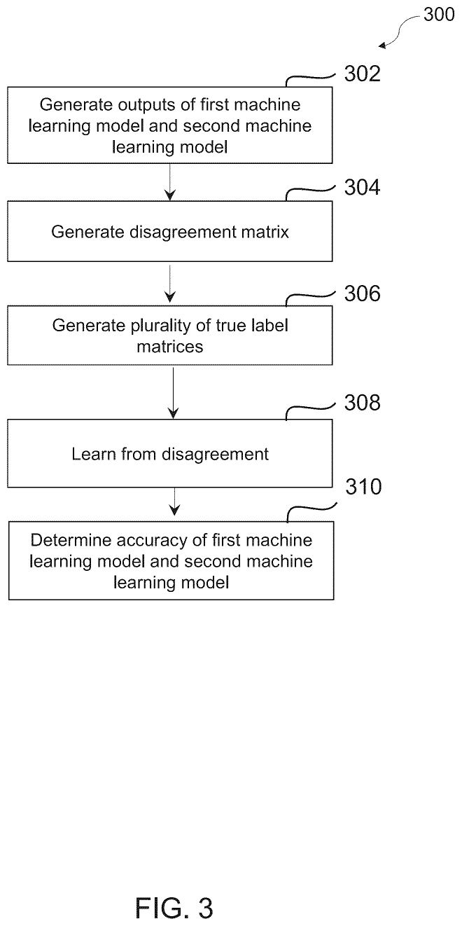

Referring now to FIG. 3, FIG. 3 is a flowchart of non-limiting embodiments or aspects of a process 300 for comparing ML models. In some non-limiting embodiments or aspects, one or more of the steps of process 300 may be performed (e.g., completely, partially, etc.) by model comparison system 102 (e.g., one or more devices of model comparison system 102). In some non-limiting embodiments or aspects, one or more of the steps of process 300 may be performed (e.g., completely, partially, etc.) by another device or a group of devices separate from or including model comparison system 102 (e.g., one or more devices of model comparison system 102), transaction service provider system 104 (e.g., one or more devices of transaction service provider system 104), user device 106, merchant system 108 (e.g., one or more devices of merchant system 108), or issuer system 110 (e.g., one or more devices of issuer system 110).

As shown in FIG. 3, at step 302, process 300 includes generating outputs of a first ML model and a second ML model. For example, model comparison system 102 may generate outputs of the first ML model and the second ML model. In some non-limiting embodiments or aspects, model comparison system 102 may receive a dataset of data instances, where each data instance comprises a feature value for each feature of a plurality of features, and model comparison system 102 may generate outputs of a first ML model and outputs of a second ML model based on the dataset of data instances.

For example, model comparison system 102 may obtain a plurality of features associated with a plurality of samples and a plurality of labels (e.g., true labels, false labels, etc.) for the plurality of samples. As an example, model comparison system 102 may generate a plurality of first predictions for the plurality of samples by providing, as input to a first ML model, a first subset of features of the plurality of features, and receiving, as output from the first ML model, the plurality of first predictions for the plurality of samples. As an example, the first ML model may be trained using or configured with a first subset of features of the plurality of features, a first set of hyperparameters, a first ML algorithm, and/or a first training data set.

For example, model comparison system 102 may generate a plurality of second predictions for the plurality of samples by providing, as input to a second ML model, a second subset of features of the plurality of features, and receiving, as output from the second ML model, the plurality of second predictions for the plurality of samples. As an example, the second ML model may be trained using or configured with a second subset of features of the plurality of features, a second set of hyperparameters, a second ML algorithm, and/or a second training data set.

Referring also to FIG. 4, FIG. 4 is a flowchart of an implementation of non-limiting embodiments or aspects of a process to compare ML models. As shown in FIG. 4, at Step 1, model comparison system 102 may feed data into the compared classifiers (A & B) to get the two classifiers' scores for individual data instances. For example, a first ML model (model A), which has been trained using or configured with a first subset of features of the plurality of features, a first set of hyperparameters, a first ML algorithm, and/or a first training data set, may be configured to receive, as input, a first subset of features of a plurality of features associated with a dataset including a plurality of samples (e.g., transaction samples, etc.), and the plurality of samples may be associated with a plurality of labels (e.g., true labels, fraud labels, false labels, non-fraud labels, etc.).

Still referring to FIG. 4, in Step 1, a second ML model (model B), which has been trained using or configured with a second subset of features of the plurality of features, a second set of hyperparameters, a second ML algorithm, and/or a second training data set, may be configured to receive, as input, a second subset of features of a plurality of features associated with the dataset including the plurality of samples (e.g., transaction samples, etc.) associated with the plurality of labels (e.g., true labels, fraud labels, false labels, non-fraud labels, etc.).

In some non-limiting embodiments or aspects, at least one of: (i) the first subset of features is different than the second subset of features; (ii) the first set of hyperparameters for an ML algorithm used to generate the first ML model is different than the second set of hyperparameters for a same ML algorithm used to generate the second ML model; (iii) the first ML algorithm used to generate the first ML model is different than the second ML algorithm used to generate the second ML model; and (iv) the first training data set used to train the first ML model is different than the second training data set used to train the second ML model. For example, the first ML model (Model A) may include a legacy model (e.g., an older model, etc.) and the second ML model (Model B) may include a new model (e.g., an updated version of the legacy model, etc.). As an example, the first subset of features for the first ML model (Model A) may include a number of declined transactions in a period of time (e.g., in a previous 30 minutes, etc.), a fraud rate in a location (e.g., in a zip code), and/or the like, and the second ML model (Model B) may include merchant embeddings, and/or the like. In such an example, the first ML algorithm in the first ML model (Model A) may include a logistic regression or gradient boosting trees, and the second ML algorithm in the second ML model (Model B) may include a deep neural network.

In some non-limiting embodiments or aspects, a sample may be associated with a transaction. For example, a feature associated with a transaction sample may include a transaction parameter, a metric calculated based on a plurality of transaction parameters associated with a plurality of transactions, and/or one or more embeddings generated therefrom. As an example, a transaction parameter may include an account identifier (e.g., a PAN, etc.), a transaction amount, a transaction date and/or time, a type of products and/or services associated with the transaction, a conversion rate of currency, a type of currency, a merchant type, a merchant name, a merchant location, a merchant, a merchant category group (MCG), a merchant category code (MCC), a card acceptor identifier, a card acceptor country/state/region, a number of declined transactions in a time period, a fraud rate in a location (e.g., in a zip code, etc.), a merchant embedding, and/or the like. In such an example, a label for a transaction may include a fraud label (e.g., an indication that the transaction is fraudulent, a true label, etc.) or a non-fraud label (e.g., an indication that the transaction is not fraudulent, a false label, etc.).

As further shown in FIG. 3, at step 304, process 300 includes generating a disagreement matrix. For example, model comparison system 102 may generate a disagreement matrix. In some non-limiting embodiments or aspects, the disagreement matrix may include a first set of grouped outputs of the first ML model and the second ML model and a second set of grouped outputs of the first ML model and the second ML model. The first set of grouped outputs may include a plurality of outputs of the first ML model that satisfies a first condition and a plurality of outputs of the second ML model that does not satisfy the first condition. In some non-limiting embodiments or aspects, the second set of grouped outputs may include a plurality of outputs of the first ML model that does not satisfy the first condition and a plurality of outputs of the second ML model that satisfies the first condition. As an example, model comparison system 102 may generate, based on the plurality of first predictions, the plurality of second predictions, the plurality of labels, and a plurality of groups of samples of the plurality of samples. As an example, model comparison system 102 may group the samples into groups of true positives and groups of false positives according to whether one of, each of, or neither of the first predictions of first ML model and the second predictions of second ML model match the labels for the samples.

In some non-limiting embodiments or aspects, model comparison system 102 may generate the disagreement matrix based on a first subset of the outputs of the first ML model and a second subset of outputs of the second ML model. In some non-limiting embodiments or aspects, model comparison system 102 may determine the first subset of the outputs of the first ML model and the second subset of outputs of the second ML model. For example, model comparison system 102 may determine the first subset of the outputs of the first ML model and the second subset of outputs of the second ML model based on one or more thresholds. In some non-limiting embodiments or aspects, the first subset of the outputs of the first ML model and the second subset of outputs of the second ML model have a same number of values.

Referring again to FIG. 4, in Step 2, model comparison system 102 may sort instances by the two sets of scores decreasingly, and set a threshold as the score cutoff (e.g., 5% of all instances). Instances with scores above the threshold may be instances captured by individual models (e.g., A⁺ and B⁺). The threshold may often depend on applications, e.g., for loan eligibility predictions, and/or the threshold may be decided by a budget of a bank. In Step 3 of FIG. 4, model comparison system 102 may join the two sets of captured instances from the two models into three cells of a disagreement matrix (e.g., A captured B missed (A⁺B⁻), A missed B captured (A⁻B⁺), and both captured (A⁺B⁺)). For comparison purposes, the A⁺B⁺ instances may be of less interest. Also, there may be no A−B⁻ instances, because the filtered instances from Step 2 of FIG. 4 may be at least captured by one model. As shown in Step 4 of FIG. 4, based on the true label of the captured instances, model comparison system 102 may divide the disagreement matrix into two matrices: one for the true positive (TP) instances (e.g., correctly captured), the other for the false positive (FP) instances (e.g., mis-captured).

In some non-limiting embodiments or aspects, generating the plurality of groups of samples of the plurality of samples includes: determining, with the at least one processor, a first group of samples of the plurality of samples for which a first prediction of the plurality of first predictions matches a label of the plurality of labels and a second prediction of the plurality of second predictions matches the label of the plurality of labels; determining, with the at least one processor, a second group of samples of the plurality of samples for which the second prediction of the plurality of second predictions matches the label of the plurality of labels and the first prediction of the plurality of first predictions does not match the label of the plurality of labels; determining, with the at least one processor, a third group of samples of the plurality of samples for which the first prediction of the plurality of first predictions matches the label of the plurality of labels and the second prediction of the plurality of second predictions does not match the label of the plurality of labels; determining, with the at least one processor, a fourth group of samples of the plurality of samples for which the second prediction of the plurality of second predictions does not match the label of the plurality of labels and the first prediction of the plurality of first predictions does not match the label of the plurality of labels; determining, with the at least one processor, a fifth group of samples of the plurality of samples for which the first prediction of the plurality of first predictions does not match the label of the plurality of labels and the second prediction of the plurality of second predictions matches the label of the plurality of labels; and determining, with the at least one processor, a sixth group of samples of the plurality of samples for which the second prediction of the plurality of second predictions does not match the label of the plurality of labels and the first prediction of the plurality of first predictions matches the label of the plurality of labels.

In some non-limiting embodiments or aspects, the plurality of first predictions includes a plurality of first prediction scores, and the plurality of second predictions includes a plurality of second prediction scores. For example, model comparison system 102 may generate the plurality of groups of samples of the plurality of samples by: aligning the plurality of second prediction scores to a same scale as the plurality of first prediction scores; applying an operating point to the plurality of first prediction scores to determine a plurality of first positive predictions and a plurality of first negative predictions; applying the operating point to the plurality of aligned second prediction scores to determine a plurality of second positive predictions and a plurality of second negative predictions; and generating, based on the plurality of first positive predictions, the plurality of first negative predictions, the plurality of second positive predictions, the plurality of second negative predictions, the plurality of labels, and the plurality of groups of samples of the plurality of samples. As an example, and referring again to FIG. 4, after receiving the first prediction scores and the second prediction scores, model comparison system 102 may align the first prediction scores and the second prediction scores to ensure that each of the first prediction scores and the second prediction scores are on a same scale (e.g., to ensure that the scores from the two models represent the same level of risk, etc.). For example, score alignment may convert disparate score values from different ranges into a same risk assessment by only modifying score values and not changing the rank order (and hence the model performance).

In some non-limiting embodiments or aspects, model comparison system 102 may align the plurality of second prediction scores to the same scale as the plurality of first prediction scores (or vice-versa) by assigning each first prediction score of the plurality of prediction scores to a first bucket of a plurality of first buckets according to a value of that first prediction score; determining, for each first bucket, a rate of positive first predictions up to the value of the first prediction score assigned to that first bucket; assigning each second prediction score of the plurality of prediction scores to a second bucket of a plurality of second buckets according to a value of that second prediction score; determining, for each second bucket, a rate of positive second predictions up to the value of the second prediction score assigned to that second bucket; and determining, for each second prediction score, an aligned score aligned to the same scale as the plurality of first predictions scores, the value of the first prediction score assigned to the first bucket of the plurality of first buckets for which the rate of positive first predictions is a same rate as the rate of positive second predictions of the second bucket to which that prediction score is assigned.

For example, the first prediction scores (model A scores) may be divided into 1000 buckets, where the first bucket corresponds to a score 0, the second bucket corresponds to a score 1, and the 1000th bucket corresponds to a score 999. In each bucket, the transaction decline rate up to the current score for that bucket may be calculated, which creates a first two-column table (referred to as Table A) where the first column is the first prediction or Model A score, and the second column is the transaction decline rate of the bucket to which that Model A score is assigned. The same process may be repeated for the second prediction scores (Model B scores), in which the second prediction scores (Model B scores) may be divided into 1000 buckets, where the first bucket corresponds to a score 0, the second bucket corresponds to a score 1, and the 1000th bucket corresponds to a score 999, and in each bucket, the transaction decline rate up to the current score for that bucket may be calculated, resulting in another two-column table (referred to as Table B). The first column of Table B is the Model B score, and the second column is the transaction decline rate of the bucket to which that Model B score is assigned. Given a score at a transaction decline rate in Table A, denoted as Score A, model comparison system 102 matches the same transaction decline rate in Table B with its corresponding score, denoted as Score B. The Score B is the aligned Model B score. For example, a Model B score with a value of Score B may have the same level of risk as a Model A score with a value of Score A. In practice, it is possible that the transaction decline rate or the score is not available in Table A or Table B and, in such a scenario, the transaction decline rate or score may be calculated using interpolation.

After aligning the plurality of second prediction scores to a same scale as the plurality of first prediction scores (or vice-versa), model comparison system 102 may apply an operating point to the plurality of first prediction scores to determine a plurality of first positive predictions and a plurality of first negative predictions and apply the operating point to the plurality of aligned second prediction scores to determine a plurality of second positive predictions and a plurality of second negative predictions. Model comparison system 102 may generate, based on the plurality of first positive predictions, the plurality of first negative predictions, the plurality of second positive predictions, the plurality of second negative predictions, the plurality of labels, and the plurality of groups of samples of the plurality of samples.

As further shown in FIG. 3, at step 306, process 300 includes generating a plurality of true label matrices. For example, model comparison system 102 may generate the plurality of true label matrices. In some non-limiting embodiments or aspects, model comparison system 102 may generate the plurality of true label matrices based on true labels of the first set of grouped outputs of the disagreement matrix and the second set of grouped outputs of the disagreement matrix. In some non-limiting embodiments or aspects, a first true label matrix of the plurality of true label matrices may include true positive outputs of the plurality of outputs of the first ML model that satisfy a first condition and true positive outputs of the plurality of outputs of the second ML model that satisfy the first condition. In some non-limiting embodiments or aspects, a second true label matrix of the plurality of true label matrices may include false positive outputs of the plurality of outputs of the first ML model that satisfy the first condition and false positive outputs of the plurality of outputs of the second ML model that satisfy the first condition.

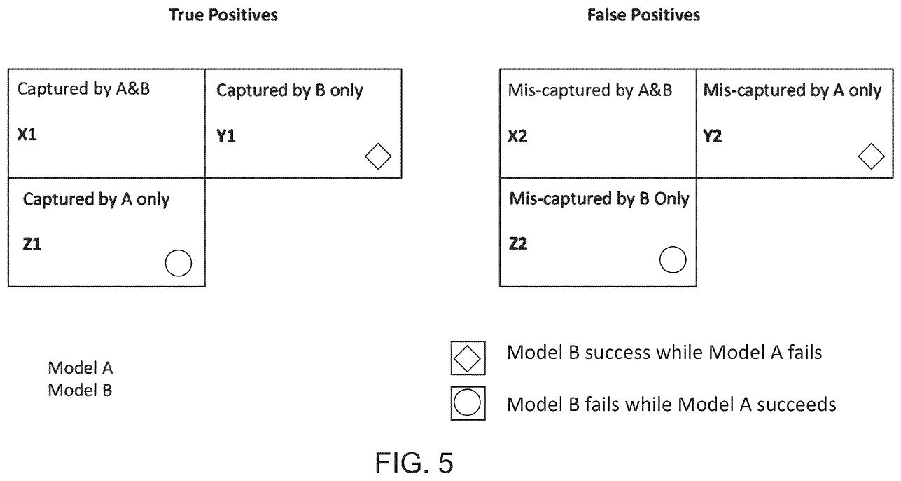

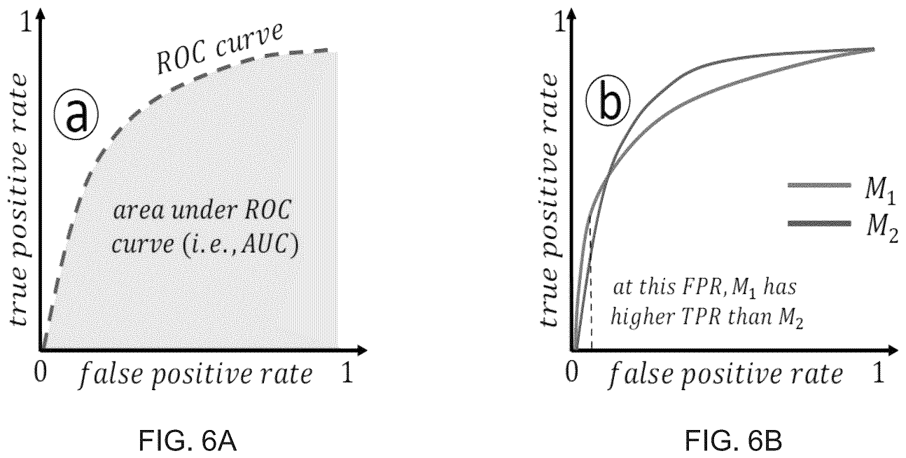

Referring also to FIG. 5, FIG. 5 is a diagram of an implementation of non-limiting embodiments or aspects of subsets of samples for calculating a performance metric. As shown in FIGS. 4 and 5, model comparison system 102 may generate the plurality of groups of samples of the plurality of samples by dividing the plurality of samples into six groups of samples represented by the boxes in Step 4 in FIG. 4 and the corresponding six boxes labeled as groups X1, Y1, Z1, X2, Y2, and Z2 in FIG. 5, with three boxes representing groups of true positives and three boxes representing groups of false positives or false declines. In FIG. 4, the two symbols “+”, and “−” are used to indicate whether or not a model is making correct predictions or decisions, where “+” means that a model is making correct decisions according to the labels, while “−” means that a model is making incorrect predictions or decisions according to the labels

For example, for the true positives: A+, B+ indicates that, for a sample labeled as a positive, both Model A and Model B successfully predict or capture the sample; A−, B+ indicates that, for a sample labeled as a positive, Model A fails to predict or capture the sample as a positive, but Model B predicts or captures the sample as a positive; and A+, B− indicates that, for a sample labeled as a positive, model A predicts or captures the sample as a positive, but Model B fails to predict or capture the sample as a positive.

As an example, for the false positives: A−, B− indicates that, for a sample labeled as a negative, each of Model A and Model B are making mistakes by predicting or flagging the sample as a positive; A−, B+ indicates that, for a sample labeled as a negative, Model A is making a mistake by predicting or flagging the sample as a positive, while Model B is making a correct decision by predicting the sample a negative; and A+, B− indicates that, for a sample labeled as a negative, Model A is making a correct decision by predicting the sample as a negative, but Model B is making a mistake by predicting or flagging the sample as a positive.

As shown in FIG. 5, group X1 may include samples associated with positive labels and predictions A+, B+, group Y1 may include samples associated with positive labels and predictions A−, B+, group Z1 may include samples associated with positive labels and predictions A+, B−, group X2 may include samples associated with negative labels and predictions A−, B−, group Y2 may include samples associated with negative labels and predictions A−, B+, and group Z2 may include samples associated with negative labels and predictions A+, B−. As also shown in FIG. 5, a diamond symbol in a box indicates that only Model B makes a correct prediction or decision for the samples in that group, a circle symbol indicates only Model A makes a correct prediction or decision for the samples in that group, and no symbol indicates that each of Model A and Model B either made all correct predictions or decisions for the samples in that group or made all incorrect predictions or decisions for the samples in that group.

For example, a first group of samples X1 of the plurality of samples may include samples for which a first prediction of the plurality of first predictions matches a label of the plurality of labels and a second prediction of the plurality of second predictions matches the label of the plurality of labels, a second group of samples Y1 of the plurality of samples may include samples for which the second prediction of the plurality of second predictions matches the label of the plurality of labels and the first prediction of the plurality of first predictions does not match the label of the plurality of labels, a third group of samples Z1 of the plurality of samples may include samples for which the first prediction of the plurality of first predictions matches the label of the plurality of labels and the second prediction of the plurality of second predictions does not match the label of the plurality of labels, a fourth group of samples X2 of the plurality of samples may include samples for which the second prediction of the plurality of second predictions does not match the label of the plurality of labels and the first prediction of the plurality of first predictions does not match the label of the plurality of labels, a fifth group of samples Y2 of the plurality of samples may include samples for which the first prediction of the plurality of first predictions does not match the label of the plurality of labels and the second prediction of the plurality of second predictions matches the label of the plurality of labels, and a sixth group of samples Z2 of the plurality of samples may include samples for which the second prediction of the plurality of second predictions does not match the label of the plurality of labels and the first prediction of the plurality of first predictions matches the label of the plurality of labels.

As further shown in FIG. 3, at step 308, process 300 includes learning from disagreement. In some non-limiting embodiments or aspects, learning from disagreement at step 308 of process 300 includes training classifiers. For example, model comparison system 102 may train a plurality of classifiers. In some non-limiting embodiments or aspects, model comparison system 102 may train a first classifier (e.g., a TP discriminator, etc.) based on the first true label matrix, and/or model comparison system 102 may train a second classifier (e.g., a FP discriminator, etc.) based on the second true label matrix.

Referring again to FIG. 4, in Step 5, model comparison system 102 may train TP and FP discriminators (e.g., two binary classifiers) to differentiate the A⁺B⁻ (negative) and A⁻B⁺ (positive) instances from the TP and FP sides, respectively. The training may use a set of meta-features, as the features of model A and model B may not be available.

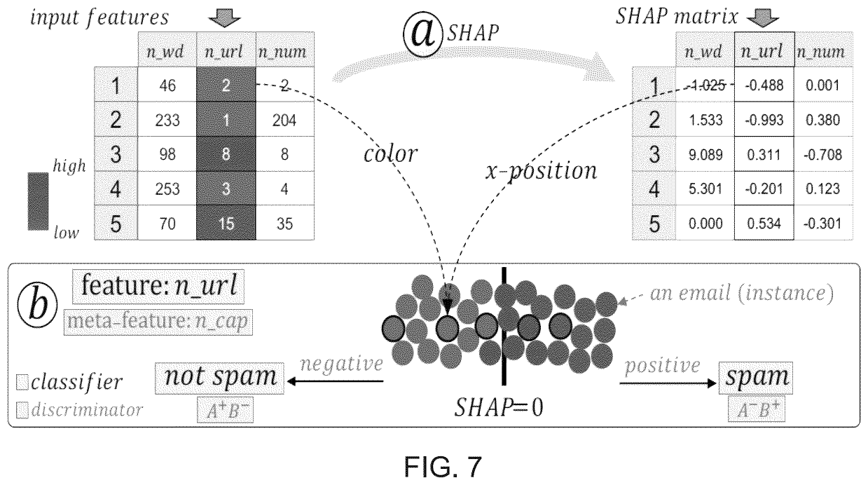

Meta-features may be used because the data features used to train classifiers A and B may not be available during comparison. Taking the example email spam filtering scenario described herein as an example, the raw data are the emails, including the email title, body, address, etc. Different classifiers derive different features for their respective training, e.g., n_wd, n_url, and n_num, etc. In industry, these classifiers may come from different teams, and it is hard to know what features were used during comparison. In contrast, ML practitioners are usually told what types of models the classifiers are built from, and the ML practitioners may have prior knowledge on different ML models. Meta-features can thus be derived based on the prior knowledge of the ML practitioners. For example, when comparing RNNs with tree-based models, sequence-related meta-features can be generated to verify if the RNNs really benefit from being aware of sequential behaviors. To compare GNNs with RNNs, neighbor-related meta-features (e.g., nodes' degree) can be proposed to reveal how much the GNNs can take advantage of the neighbors' information. Even if little information of the compared classifiers is provided, one can still propose new meta-features to probe the behavior differences between the two classifiers. For example, and referring to FIG. 7, n_cap (e.g., the number of capitalized words) may be proposed to probe how the compared spam classifiers would be impacted by this meta-feature (though it may not be known what the compared classifiers are). Accordingly, meta-features are not the features used to train models A or B. However, non-limiting embodiments or aspects of the present disclosure are not limited thereto, and the training features (e.g., samples) from models A or B may be used as meta-features if they are available.

A discriminator (e.g., the TP discriminator, the FP discriminator, etc.) can be any binary classifier that is SHAP-friendly (e.g., XGBoost, etc.). Based on the SHAP of different meta-features, insights into the two compared classifiers can be provided. For example, if the discriminator shows the SHAP view in FIG. 7 (the labels in the green boxes), it can be concluded that “compared to classifier A, classifier B tends to capture emails containing more capitalized words (n_cap is a meta-feature)”. If the discriminator is the TP discriminator, it can be determined that classifier B outperforms classifier A when this feature is large (correctly captures more). However, if the discriminator is the FP discriminator, classifier Bis not as good as classifier A, as it miscaptures more when the feature value is large.

In this way, LFD may provide the following direct advantages. LFD may be model-agnostic, because LFD may use only the input and output from the two compared models, making it a generally applicable solution to compare any types of classifiers. LFD is feature-agnostic, because LFD may compare classifiers based on newly proposed meta-features, which are independent of the original model-training features (that are usually not available during comparison). LFD may avoid data-imbalance. For example, for many real-world applications (e.g., click-through rate (CTR) predictions), data-imbalance (e.g., positive instances are much fewer than negative instances) brings a big challenge to model training and interpretation. LFD smartly avoids this imbalance, as it compares the difference between two models (e.g., the two “captured-only” cells usually have similar sizes).

A feature analysis may reveal how an input feature impacts an output of a model or classifier and a magnitude of the impact. SHAP, which is described by M. Lundberg and S.-I. Lee in the paper titled “A unified approach to interpreting model predictions,” in Advances in neural information processing systems, 2017, pp. 4765-4774, the entire contents of which are incorporated by reference, is one solution for this analysis that is consistent, additive, and can be computed efficiently.

FIG. 7 illustrates an example dataset and interpretation matrix for a spam classifier. For example, a tabular dataset (e.g., input features) with n instances and m features may be considered as a matrix of size n×m. The example dataset has five instances (e.g., emails), each with three features: the word count (n_wd), the number of URLs (n_url), and the count of numerical values (n_num) in an email. To interpret the classifier's behavior on this dataset, SHAP generates an interpretation matrix (e.g., SHAP matrix), which has the size of n×m. Each element of this matrix, [i, j], denotes the contribution of the jth feature to the prediction of the ith instance. For example, the sum of all values from the ith row of the SHAP matrix may be the classifier's final prediction for the ith instance (e.g., the log(odds), which may go through a sigmoid( ) to become a final probability value, etc.).

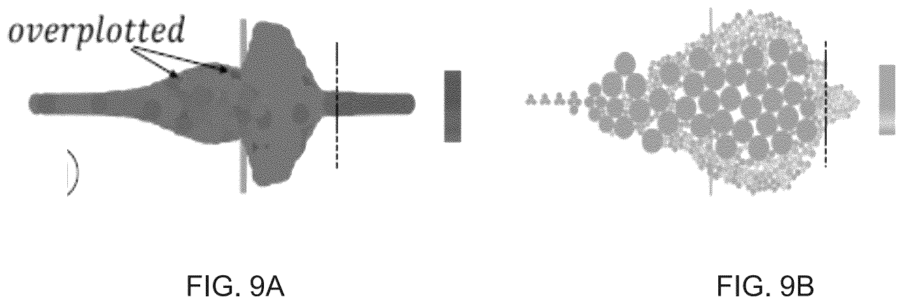

The SHAP summary-plot, which is described by S. M. Lundberg, G. G. Erion, and S.-I. Lee in the paper titled “Consistent individualized feature attribution for tree ensembles,” arXiv:1802.03888, 2018, the entire contents of which are incorporated by reference, is designed to visualize the effect of individual features to a prediction of a classifier. For example, to show the impact of n_url to the example spam classifier, the summary-plot encodes each email as a point. In FIG. 7, the color and horizontal position of the point reflects the corresponding feature and SHAP value, respectively. The five points with black strokes or edges in FIG. 7 show the five emails. Extending the plot to more emails/instances, an impact of a feature can be determined from the collective behaviors of the instances (e.g., emails with more URLs (the red points with larger positive SHAP) are more likely to be spam, etc.). The impact of other features can be visualized and vertically aligned with this feature (e.g., as shown along the SHAP=0 line in FIG. 9B). These features may be ordered based on their importance to the classifier, where n is the number of instances, which may be computed according to the following Equation (1):

$$mean ( \vert SHAP \vert ) = \frac{1}{n} {\sum }_{i = 1}^{n} \vert SHAPi \vert \qquad ( 1 )$$

Accordingly, as shown in FIG. 7, interpreting behavior of a classifier on a dataset with SHAP may generate an interpretation matrix sharing the same size with the input, and the contribution of a feature using the summary-plot may be visualized (e.g., the red labels in the blue boxes). In this example scenario, the collective behavior of all instances reflects that emails with higher n_url are more likely to be spam. The summary-plot can also interpret the discriminator from LFD (e.g., read labels in the green boxes), which reflects that emails with higher n_cap (e.g., a meta-feature) are more likely to be captured by model B but missed by model A (e.g., A⁻B⁺).

Model ensembling, which is described by Z.-H. Zhou in the paper titled “Ensemble methods: foundations and algorithms”. CRC press, 2012, the entire contents of which are incorporated by reference, is the research of combining multiple pre-trained models to achieve better performance than individual models. A naïve way of ensembling two models is to train a linear regressor to fit scores from the two pre-trained models, which is known as linear stacking. Considering the data instance x and two pre-trained models Mₐ and M_{b}, the linear stacking result LS(x) may be computed according to the following Equation (2):

LS(x)=w₁·Mₐ(x)+w₂·M_{b}(x) (2)

Feature-weighted linear stacking (FWLS), which is described by J. Sill, G. Takács, L. Mackey, and D. Lin in the paper titled “Feature-weighted linear stacking,” arXiv preprint arXiv:0911.0460, 2009, the entire contents of which are incorporated by reference, is a state-of-the-art model ensembling solution, claiming that the weights (w₁ and w₂ in Equation (2)) should not be fixed but vary based on different feature-values because the two models may have varying performances in different feature value ranges. FWLS, therefore, combines data features with models' scores by feature-crossing and trains the regressor on the crossed features. The weights w₁ and w₂ become m pairs of weights w₁ⁱ (and w₂ⁱ), where m is the number of features and Fᵢ(x) retrieves the ith feature value of x according to the following Equation (3):

$$FWLS ( x ) = {\sum }_{i = 1}^{m} [ {w}_{1}^{i} \cdot ( {M}_{a} ( x ) \cdot {F}_{i} ( x ) ) + {w}_{2}^{i} \cdot ( {M}_{b} ( x ) \cdot {F}_{i} ( x ) ) ] \qquad ( 3 )$$

As the number of features may be large, FWLS can be conducted using a subset of the features. However, incautiously selected features may impair the ensembling result. Therefore, properly ranking the features and choosing the most impactful or important ones for ensembling becomes a problem.

In some non-limiting embodiments or aspects, learning from disagreement at step 308 of process 300 additionally, or alternatively, includes determining a relative success rate of a first ML model and a second ML model. For example, model comparison system 102 may determine a relative success rate of the first ML model and the second ML model. As an example, model comparison system 102 may determine a relative success rate including a first success rate associated with the first ML model and a second success rate associated with the second ML model. For example, model comparison system 102 may determine, based on the plurality of groups of samples, a first success rate associated with the first ML model and a second success rate associated with the second ML model.

A first success rate (Model A success rate) associated with a first ML model may be determined according to the following Equation (4):

$$First Success Rate ( Model A ) = \frac{X 1 + Z 1 + λ ( Z 2 )}{X 1 + Y 1 + Z 1 + λ ( X 2 + Y 2 + Z 2 )} \qquad ( 4 )$$

where X1 is a number of samples and/or an amount associated with the number of samples (e.g., a transaction amount, etc.) in a first group of samples; X1, Y1 is a number of samples and/or an amount associated with the number of samples (e.g., a transaction amount, etc.) in a second group of samples; Y1, Z1 is a number of samples and/or an amount associated with the number of samples (e.g., a transaction amount, etc.) in a third group of samples; Z1, X2 is a number of samples and/or an amount associated with the number of samples (e.g., a transaction amount, etc.) in a fourth group of samples; X2, Y2 is a number of samples and/or an amount associated with the number of samples (e.g., a transaction amount, etc.) in a fifth group of samples; Y2, Z2 is a number of samples and/or an amount associated with the number of samples (e.g., a transaction amount, etc.) in the sixth group of samples; and λ is a discount factor.

A second success rate (Model B success rate) associated with a second ML model may be determined according to the following Equation (5):

$$Second Success Rate ( Model B ) = \frac{X 1 + Y 1 + λ ( Y 2 )}{X 1 + Y 1 + Z 1 + λ ( X 2 + Y 2 + Z 2 )} \qquad ( 5 )$$

where X1 is the number of samples and/or the amount associated with the number of samples (e.g., a transaction amount, etc.) in the first group of samples; X1, Y1 is the number of samples and/or the amount associated with the number of samples (e.g., a transaction amount, etc.) in the second group of samples; Y1, Z1 is the number of samples and/or the amount associated with the number of samples (e.g., a transaction amount, etc.) in the third group of samples; Z1, X2 is the number of samples and/or the amount associated with the number of samples (e.g., a transaction amount, etc.) in the fourth group of samples; X2, Y2 is the number of samples and/or the amount associated with the number of samples (e.g., a transaction amount, etc.) in the fifth group of samples; Y2, Z2 is the number of samples and/or an amount associated with the number of samples (e.g., a transaction amount, etc.) in a sixth group of samples; and λ is the discount factor.

In this way, for Equation (4) for the first success rate associated with the first ML model (Model A), group X1 includes frauds captured by both Model A and Model B, causing X1 to be counted as a success for the first ML model (Model A). Group Z1 includes frauds captured exclusively by the first ML model (Model A), causing Z1 to also be counted as a success for the first ML model (Model A). Group Z2 includes false positives from the second ML model (Model B) but not from the first ML model (Model A), causing Z2 to be counted as a success for the first ML model (Model A). For example, group Z2 includes legitimate transactions, and the second ML model (Model B) mistakenly predicts the legitimate group Z2 transactions as fraud and declines the legitimate group Z2 transactions, but the first ML model (Model A) correctly predicts the group Z2 transactions as legitimate and authorizes the group Z2 transactions. Because the first ML model (Model A) does not make mistakes on the group Z2 transactions, the first ML model (Model A) is given credit in the relative performance metric for correctly predicting these transactions. On the other hand, because a loss from a false positive is not as serious as a loss from a fraud, a discount λ may be applied to the credit given to the first ML model (Model A) for the group Z2 transactions. A denominator of Equation (4) for the first success rate associated with the first ML model (Model A) may include a sum of all fraud and false positives with the discount A. Equation (5) for the second success rate associated with the second ML model (Model B) is calculated in a similar manner by replacing Z1 and Z2 in the numerator with Y1 and Y2 to give the second ML model (Model B) credit for the fraudulent group Y1 transactions captured only by the second ML model (Model B) and the legitimate group Y2 transactions correctly predicted by only the second ML model (Model B).

Accordingly, non-limiting embodiments or aspects of the present disclosure provide a relative success rate that is a relative performance metric designed for evaluating the performance of a pair of models and that adds a cost to an incorrect decision. This relative performance metric enables comparing a pair of models at a given operating point or score cutoff by learning from disagreement (LFD) between the two models to find a difference between the two models (e.g., a weak point in one of the two models with respect to the other of the two models, etc.). For example, if a fraudulent transaction is captured by Model A, the transaction may be counted as a success of Model A, and if a legitimate transaction is declined by Model B, but not by Model A, the transaction may also be counted as a success of model A, but with a discount factor. This relative performance metric further adds a cost to an incorrect decision. For example, if a consumer spends $100 for a pair of shoes with a credit card, for the $100, a card issuer may receive $2, an acquiring bank may receive $0.50, and the transaction service provider may receive $0.18 from the two banks, resulting in the merchant only receiving $97.50 of the $100. If this $100 transaction is fraudulent, and a fraud prediction model predicts the transaction as fraud and declines the transaction, $100 is saved, and each of the parties to the transaction is happy. However, if the $100 transaction is legitimate, and the fraud prediction model declines the transaction by mistake, the card issuer, the acquiring bank, and the transaction service provider do not receive any payment, the merchant loses revenue, and the consumer has a bad experience. The relative performance metric thus adds a cost to an incorrect decision to capture this loss.

As further shown in FIG. 3, at step 310, process 300 includes determining accuracy of the first ML model and the second ML model. For example, model comparison system 102 may determine an accuracy of the first ML model and the second ML model. In some non-limiting embodiments or aspects, model comparison system 102 may determine the accuracy of the first ML model and the accuracy of the second ML model based on the first classifier and/or the second classifier. In some non-limiting embodiments or aspects, model comparison system 102 may determine the accuracy of the first ML model and the accuracy of the second ML model based on the relative success rate.

In some non-limiting embodiments or aspects, model comparison system 102 may determine the accuracy of the first ML model and the accuracy of the second ML model based on a model interpretation technique that is performed on the first classifier and/or the second classifier. In some non-limiting embodiments or aspects, the model interpretation technique may include a model interpretation technique that involves SHAP values. In some non-limiting embodiments or aspects, model comparison system 102 may calculate a SHAP value for each feature value of each data instance of the dataset for the first classifier and/or a SHAP value for each feature value of each data instance of the dataset for the second classifier. In some non-limiting embodiments or aspects, model comparison system 102 may generate a plot of the SHAP value for each feature value of each data instance of the dataset for the first classifier and/or the SHAP value for each feature value of each data instance of the dataset for the second classifier. In some non-limiting embodiments or aspects, model comparison system 102 may generate a plot of a plurality of SHAP values for a plurality of feature values of a first feature of each data instance of the dataset for the first classifier and/or a plurality of SHAP values for a plurality of feature values of the first feature of each data instance of the dataset for the second classifier.

In some non-limiting embodiments or aspects, model comparison system 102 may calculate an accuracy metric value associated with an accuracy metric of a first feature for the first classifier. In some non-limiting embodiments or aspects, the accuracy metric value associated with the accuracy metric of the first feature for the first classifier is based on a plurality of SHAP values for a plurality of feature values of the first feature of each data instance of the dataset for the first classifier. In some non-limiting embodiments or aspects, model comparison system 102 may calculate an accuracy metric value associated with the accuracy metric of the first feature for the second classifier. In some non-limiting embodiments or aspects, the accuracy metric value associated with the accuracy metric of the first feature for the second classifier is based on a plurality of SHAP values for a plurality of feature values of the first feature of each data instance of the dataset for the second classifier. In some non-limiting embodiments or aspects, the accuracy metric may include a metric associated with a measure of magnitude of a feature, a metric associated with a measure of consistency of a feature, a metric associated with a measure of contrast of a feature, and/or a metric associated with a measure of correlation of a feature.

Referring again to FIG. 4, in Step 6, model comparison system 102 may visualize/interpret the discriminators by SHAP to provide insights into the fundamental difference between models A and B. The insights may also help to rank the meta-features and pick the best ones to ensemble models A and B.

Referring again to FIG. 4, non-limiting embodiments or aspects of the present disclosure provide for visual presentation of at least the following: (1) disagreement matrices under different cutoffs (e.g., Steps 2-4 in FIG. 4) and (2) meta-features and their interpretations (e.g., Step 6 in FIG. 4). For example, a Disagreement Distribution View is provided to visualize the disagreement matrices under different cutoffs, and a Feature View is provided to visualize the meta-features and their interpretations.

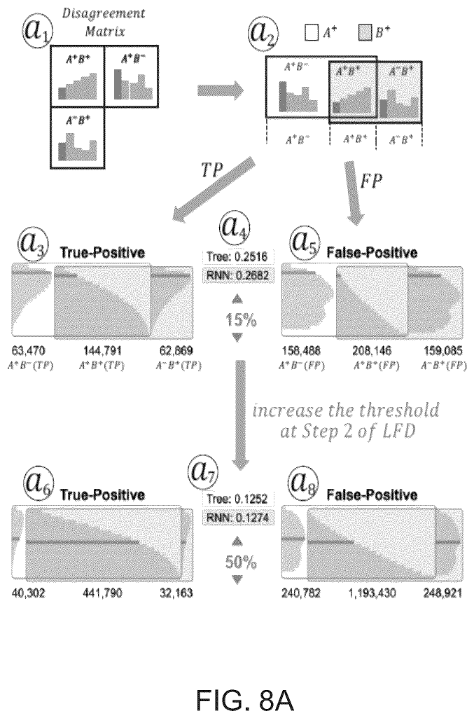

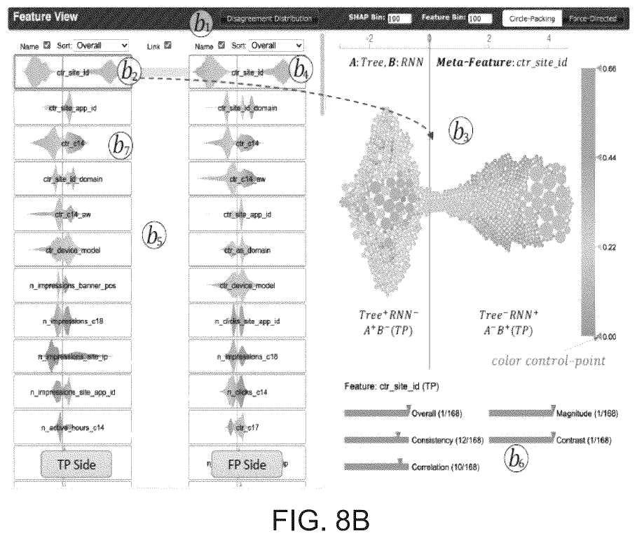

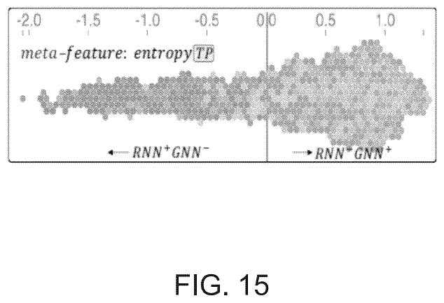

FIG. 15 shows an example Disagreement Distribution View designed to present the distribution of data instances across the six cells of the two disagreement matrices (Step 4 of FIG. 4) under different thresholds (Step 2 of FIG. 4). Given a threshold at Step 2 of FIG. 4, model comparison system 102 may filter out two sets of instances captured by model A and model B, respectively. These two instances are joined into three cells at Step 3 of FIG. 4 (e.g., A⁺B⁺, A⁺B⁻, and A⁻B⁺). The red bars at reference number a₁ in FIG. 8A denote the size of the three cells under the current threshold. When changing the threshold, the size of the three cells automatically changes accordingly. Thus, a sequence of values inside each cell (the sequence of green bars) is presented, denoting the cell sizes across all possible thresholds. This distribution overview guides users to select a proper threshold to maximize the size of disagreed data for learning.

To better encode the data joining process, a white and a gray background rectangle is used to represent the instances captured by models A and B, respectively (e.g., A⁺ and B⁺ at reference number a₂). Their overlapped region reflects the instances captured by both (A⁺B⁺) and the non-overlapped regions on the two sides are the instances captured by one only (A⁺B⁻ and A⁻B⁺). The width of the rectangles (and the overlapped region) may be proportional to the number of instances.

At Step 4 of FIG. 4, the disagreement matrix at reference number a₂ of FIG. 8A is divided into two matrices when considering the label of the instances. Meanwhile, at reference number a₃, the three green bar charts are rotated 90 degrees and present the current threshold value in the middle of the two disagreement matrices. At reference number a₄, the threshold is 15% and the corresponding bars in the six disagreement matrix cells are highlighted in the red bars at reference number as for the TP side and at reference number a₅ for the FP side.

The two triangles at reference number a₄ enable flexibly adjusting the threshold from Step 2 of FIG. 4. For example, the current threshold shown at reference number a₄ in FIG. 8A is 15% and the cutoff scores for the two compared models, Tree (A) and RNN (B), are 0.2516 and 0.2682 respectively. Instances with respective scores larger than these are captured by individual models. When increasing the threshold to 50% as shown at reference number a₇ (e.g., relaxing the filtering criteria, etc.), the overlapped cell becomes larger in the display but the two “captured-only” cells become smaller in the display at reference numbers a₆ and as). The white and gray rectangles may be overlapped completely when the threshold becomes 100%. Note that, the Disagreement Distribution View may be hidden from the visual interface by default, and/or users may enable the Disagreement Distribution View by clicking the button at reference number b₁ in the visual interface shown in FIG. 8B. Several alternative designs may be used to present the disagreement matrices. For example, the three cells may be laid out in the way they are placed at reference number a₁ in FIG. 8A, which layout is intuitive, but it is not space-efficient as the bottom-right corner is always empty.

Accordingly, non-limiting embodiments or aspects of the present disclosure may present the distribution of data instances across the six cells of the two disagreements under the different thresholds in a manner that is easy for ML experts to understand, that metaphorizes the joining process through two overlapped rectangles, and inherently, encodes the cell size into the width of the overlapped/non-overlapped regions.

FIG. 8B shows an example Feature View designed for use in Step 6 of FIG. 4 by presenting the meta-features from both the TP and FP discriminators through an “Overview+Details” exploration. The Feature View is designed to interpret the TP and FP discriminators to explain the impact of different meta-features on the captured and mis-captured instances, compare the contribution of the same meta-feature to the TP and FP discriminators, and interpret the difference with as little as possible information. The Feature View design starts from a traditional summary plot (e.g., as shown in FIG. 7, etc.), but addresses two limitations of the summary plot with respect to visualization accuracy and feature importance order.

The accuracy of the summary-plot may be undermined if the number of instances is large. As previously explained with respect to FIG. 7, each instance may be represented as a point. Within the limited space, numerous points may be overplotted and stacked vertically, which may result in misleading visualizations. For example, FIG. 9A shows a real example (generated using the Python package SHAP). At first glance, it seems large feature values (the red points on the right of the dashed line) always contribute positively to the prediction. However, there are also red points being plotted under the blue ones on the left that are less visible.

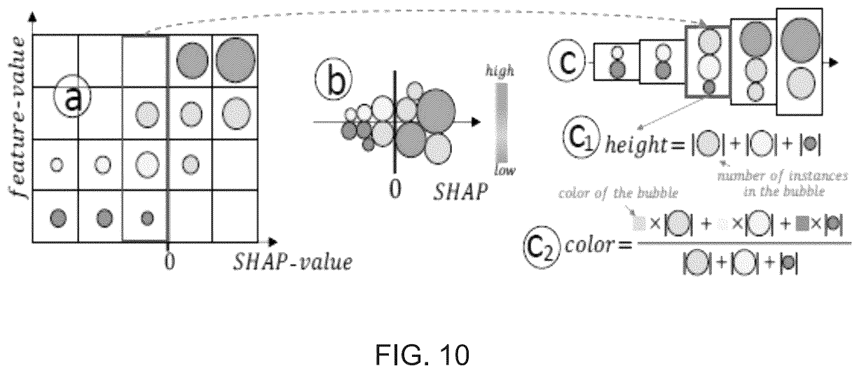

This overplotting issue may be fixed by visualizing data distributions as bubbles, rather than individual instances as points. For example, as shown in FIG. 10 at reference number a, a 2D histogram of feature- and SHAP-values (e.g., based on the two matrices in FIG. 7) may be constructed. Non-empty cells of the histogram may be represented with bubbles whose size denotes the number of instances. These bubbles are packed along the x-axis (without overlap) based on their SHAP values, using circle packing or force-directed layouts as shown at reference number b in FIG. 10. For example, the circle packing algorithm may sequentially place bubbles in tangent to each other while striving to maintain their x-position. Similarly, the force-directed algorithm may resolve the overlap among bubbles by iteratively adjusting the bubbles' positions, while also trying to retain the bubbles' x-position. A final visualization, which is shown in FIG. 9B, resolves the overplotting issue (e.g., many large value instances on the left are visible now). Note that the number of bubbles is bounded by the product of the number of feature-bins and SHAP-bins in the 2D histogram. Therefore, the number of bubbles may be controlled by adjusting the number of bins (for different levels of visual granularity).

This new design, however, cannot accurately reflect the data distribution for two reasons. First, it cannot guarantee to position a bubble at its exact x-position, as circles may get shifted to be packed tightly. Second, the size mapping between the number of instances and the bubble size can also cause issues. For example, to make sure bubbles are not too big or too small, size clipping is often applied. If the biggest bubble represents 100 instances, bubbles with 1000 instances may have the same size and the accumulated area of bubbles cannot accurately reflect the data distribution. To fix this problem, non-limiting embodiments or aspects of the present disclosure may draw the data distribution as a set of horizontally stacked rectangles as shown at reference number c in FIG. 10, whose height accurately reflects the number of instances in the corresponding SHAP bin as illustrated at reference number c₁. The color of a rectangle may be blended through a weighted-sum of all bubbles in the SHAP bin as shown at reference number c₂. Increasing the granularity of the SHAP bins, a final area-plot visualization for one feature may be achieved as shown at reference number b2 in FIG. 8B.

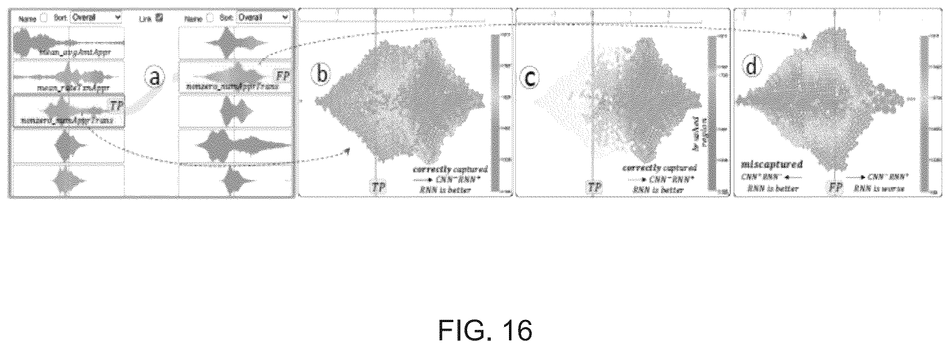

To guarantee interpretation accuracy (e.g., to disclose the behavior difference of the two compared classifiers on a user-proposed meta-feature, etc.) and enable interactivity, each design in FIG. 10 may be employed through an “Overview+Details” design or visualization interface. Each of the meta-features from the TP and FP discriminators may be presented as two columns of area-plots for an overview, where the same features are connected across columns as shown at reference number b₅ of FIG. 8B to compare the contribution of the same meta-feature to the TP and FP discriminators, and interpret the difference with as little as possible information. When clicking a meta-feature in the visual interface, the details of the meta-feature may be shown using the bubble-plot as shown at reference number b3 in FIG. 8B. An interactive “transfer function” may be provided in which users can add/drag/delete the control-points on the legend to change the color mapping. Brushing the legend may select bubbles with feature values in the brushed range (e.g., as shown in FIG. 16).

In real-world applications, it is very common to work with hundreds of features. Effectively identifying the more impactful or important ones can be used to improve model ensembling. The summary-plot prioritizes features by mean(|SHAP|), which is an effective metric in reflecting the magnitude of features' SHAP values. For example, a magnitude of a feature's SHAP value may be computed according to the following Equation (6):

$$\begin{matrix}Magnitude = \frac{1}{n} {\sum }_{i = 1}^{n} \vert {SHAP}_{i} \vert , & n is the number of instances .\end{matrix} \qquad ( 6 )$$

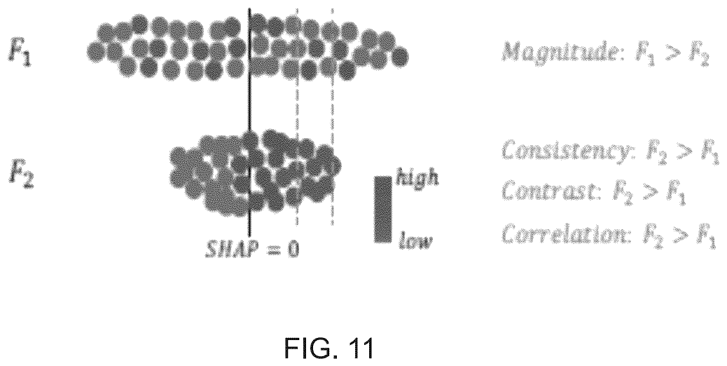

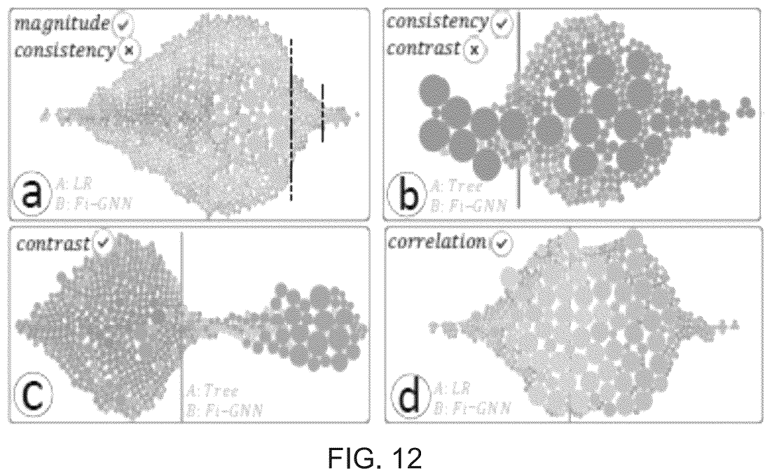

However, this magnitude metric often fails to bring the most impactful or important features up. For example, and referring now to FIG. 11, feature F₁ may be more important than feature F₂ as its magnitude is larger. However, feature F₂ may be more consistent and more contrast compared to feature F₁. As an example, feature F₁ may have a larger absolute magnitude than F₂, as the points are distributed more widely in the horizontal direction. However, the contribution of F₁ may be less consistent than F₂. For example, within the two dashed lines, both small and large F₁ values (blue and red points) may have positive contributions to the final prediction. In contrast, only large F₂ values may contribute positively. For example, FIG. 12 shows at reference number a a real large-magnitude feature. Although the feature's contribution magnitude is large, its contribution is not consistent, as the blue and orange bubbles are mixed within any vertical range. In this way, measuring features' importance by their contribution magnitude only may not be sufficient.

To address this issue, non-limiting embodiments or aspects of the present disclosure provide a consistency metric that may be computed by (1) calculating the entropy of the feature-values in each SHAP bin (e.g., a column of cells in FIG. 10), (2) summing up the entropy from each SHAP bin, using the number of instances in each bin as the weight, and (3) taking the inverse of the sum value. For example, a consistency metric according to non-limiting embodiments or aspects of the present disclosure may be computed according to the following Equation (7):

$$Consistency = {( \frac{1}{n} {\sum }_{i = 1}^{m} ℋ ( F ( x ) , ∀ x ∈ {bin}_{i} ) \times \vert {bin}_{i} \vert )}^{- 1} , n = {\sum }_{i = 1}^{m} \vert {bin}_{i} \vert , \qquad ( 7 )$$

where F(x) retrieves the feature-value of data instance x, |binᵢ| denotes the size of a bin, H( ) computes the entropy, and m is the number of SHAP bins. As shown at reference number b of FIG. 12, a real feature with high consistency, reflected by the homogeneous color of bubbles within different SHAP bins (horizontal ranges) may thus be presented. However, this feature is not very useful in differentiating the predictions either, because small feature values (in blue) are largely distributed on both sides of the SHAP=0 line, and could contribute both positively and negatively. Consequently, solely relying on the consistency metric may not effectively identify important features either.

To capture features with clear contribution differences, non-limiting embodiments or aspects of the present disclosure provide a contrast metric, which may be computed by the Jensen-Shannon divergence between two normalized distributions formed by the feature-values with positive and non-positive SHAP values. For example, a contrast metric according to non-limiting embodiments or aspects of the present disclosure may be computed according to the following Equation (8):

Contrast=JSD( [symbol] (F(x)|SHAPᵤ<=0)∥ [symbol] (F(x)|SHAPᵤ>0)) (8)

where D( ) denotes the operation of forming a normalized distribution from a set of values. A typical contrast feature is illustrated at reference number c of FIG. 12. This feature is a very good one as it has very clear feature contributions. Large feature values (orange bubbles) may always contribute positively and small values (blue bubbles) may always contribute negatively.

Non-limiting embodiments or aspects of the present disclosure provide an absolute Pearson Correlation between the SHAP-values and feature-values. This metric further enhances the contrast metric by revealing if the feature-values are linearly correlated with their contributions or not. A feature with a large correlation is shown at reference number d in FIG. 12. Smaller feature-values (in darker blue) contribute more positively to the prediction and the contribution is roughly monotonic (e.g., from left to right, the color changes from dark orange, light orange, light blue, to dark blue).

Accordingly, non-limiting embodiments or aspects of the present disclosure recognize that the features' importance should be evaluated from multiple perspectives, and thus, may integrate the four metrics with a weighted-sum to generate a fifth metric, e.g., an overall metric. An overall metric according to non-limiting embodiments or aspects of the present disclosure may be computed according to the following Equation (9):

Overall=2×Magnitude+Consistency+2×Contrast+Correlation (9)

It is noted that the weights in Equation (9) may be derived based on preliminary studies with the Avazu dataset; however, the weights may be different for different datasets.

The TP and FP discriminators may have the same set of meta-features, and they are presented as two columns, which can be easily ordered by the five metrics as shown at reference number b₅ in FIG. 8B to effectively rank meta-features from different perspectives and use the more impactful or important meta-features (e.g., more complementary meta-features) to improve model ensembling. The same features across columns may be linked by a curve for tracking to compare the contribution of the same meta-feature to the TP and FP discriminators, and interpret the difference with as little as possible information. Ranks of the selected feature in all five metrics may be provided as shown at reference number be in FIG. 8B.

### Case Studies

Described below are example cases of using LFD in two real-world applications: (1) merchant category verifications from the payment and financial services industry; and (2) CTR predictions for advertising. The cases were conducted together with ML experts. A guided exploration with a think-aloud approach was used as the protocol to conduct the case studies in three steps: (1) explaining the high-level goals of LFD and the visualizations; (2) guiding the experts to flexibly explore the cases and explaining to them the system components and corresponding findings; and (3) an open-ended interview to collect their feedback and suggestions.

In the financial services industry, each registered merchant has a category reflecting its service type (e.g., restaurants, pharmacies, casino gaming, etc.). The category of a merchant may get misreported for various reasons (e.g., high-risk merchants may report a fake category with a lower risk to avoid high processing fees, etc.). Therefore, some systems may verify the category reported by each merchant. The credit card transactions of a merchant, depicting the characteristic of its provided service, are often used to solve this problem.

Four classifiers are introduced for this problem: a Tree model, a CNN, an RNN, and a GNN. For simplicity, this example compares binary classifiers for restaurant verification only (e.g., positive label: restaurant, negative label: non-restaurant). The classifiers take a merchant as input and output its probability of being a restaurant.

The Tree model is an XGBoost model, which consumes data in tabular format (rows: merchants, columns: features). The CNN takes sequential features of individual merchants as input (each sequence denotes the values of a merchant's feature across time). The CNN captures temporal behaviors through 1D convolutions in residual blocks. The RNN also captures the merchants' temporal behaviors, but through gated recurrent units (GRUs). The GNN takes both the temporal and affinity information of a merchant into consideration. The temporal part is managed by 1D convolutions, whereas the affinity part is derived from a graph of merchants. Two merchants are connected if at least one cardholder visited both, and the strength of the connection is proportional to the number of shared cardholders. A GNN is then built to learn from this weighted graph of merchants.

More details on the models' architectures can be found in the paper by C.-C. M. Yeh, Z. Zhuang, Y. Zheng, L. Wang, J. Wang, and W. Zhang, titled “Merchant category identification using credit card transactions,” in IEEE International Conference on Big Data (Big Data), 2020, pp. 1736-1744, the entire contents of which are incorporated by reference. However, LFD does not need these details because LFD is model-agnostic. From the training data (e.g., raw transactions), the four models use different feature extraction methods to derive their respective training features in different formats (e.g., some are in tabular form and some are in sequences, etc.). Even if there is little knowledge about the features used by different classifiers, the classifiers can still be compared with LFD because LFD is feature-agnostic. For the example comparisons, there are 3.8 million merchants with their raw transactions in 2.5 years. The models are compared using LFD and the derived insights are verified with the experts.

The Tree model and the RNN are compared. The Tree has a higher area-under-curve (AUC) (e.g., the Tree outperforms the RNN), whereas the RNN has a lower LogLoss (e.g., the RNN outperforms the Tree). The performance reflected by the two metrics conflicts with each other, and it is hard to choose models based on these two metrics. Also, the metrics reflect the models' performance on a specific set of test data, but reveal nothing about the models' behaviors on different features. However, in practice, ML practitioners often need to select models based on feature-value distributions. For example, one may select spam classifiers behaving better on emails with more URLs if he/she knows that most of the coming emails will have many URLs.

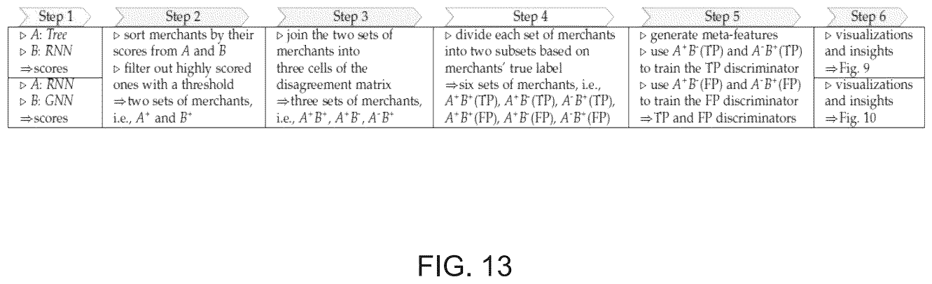

Referring now to FIG. 13, using LFD, the Tree (A) and RNN (B) are compared as shown in the top row of FIG. 13. Step 1 feeds the 3.8 million merchants to the two models and generates two scores for each merchant. Step 2 uses these scores to sort the merchants decreasingly. Based on a given threshold, the merchants predicted as restaurants (e.g., captured) by model A and B, respectively (e.g., A+ and B+) are filtered out. Step 3 joins these two sets and separates the merchants into three cells (e.g., A+B+, A+B−, and A−B+). Based on the merchants' true label, each cell is further divided into two smaller cells at Step 4 (e.g., there are six sets of merchants in total).

Step 5 generates 70 meta-features for each merchant from the merchant's raw transactions (over the past 2.5 years). It is not necessary to explain each meta-feature, but meta-features used in this example case and mentioned later herein include: nonzero_numApprTrans, nonzero_amtDeclTrans, mean_avgAmtAppr, mean_rateTxnAppr, and mean_numApprTrans.

The meta-feature nonzero_numApprTrans may include a number of days that a merchant has at least one approved transaction in a time period (e.g., the 2.5 years). For time-series data, this meta-feature reflects the number of meaningful points in a sequence. It is derived based on the prior knowledge that RNNs often behave better on instances with richer sequential information. Its value range may be [0, 912] (2.5 years=912 days), reflecting the active level of a merchant. The meta-feature nonzero_amtDeclTrans may include the number of days that a merchant has at least one declined transaction (with a nonzero dollar amount) in a time period (e.g., the 2.5 years). The meta-feature mean_avgAmtAppr may include the mean of the average approved amount per day, over a time period (e.g., the 2.5 years), for each merchant. The meta-feature mean_rateTxnAppr may include the mean of the daily transaction approval rate, over a time period (e.g., the 2.5 years), for each merchant. The meta-feature mean_numApprTrans may include the mean of the number of daily approved transactions, over a time period (e.g., the 2.5 years), per merchant. Using all 70 meta-features of the merchants in the A+B− and A−B+ cells from the TP side, the TP discriminator is trained. The FP discriminator is trained using the same meta-features, but by using the merchants from the corresponding FP cells.

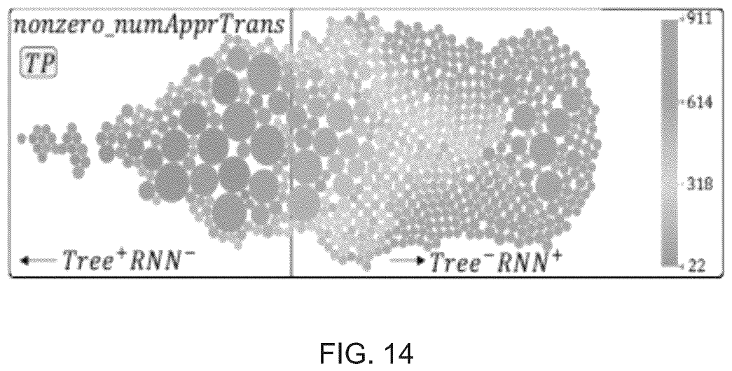

Step 6 interprets the discriminators to derive insights. For example, from a visualization of nonzero_numApprTrans in the TP side as shown in FIG. 14, it may be determined that active merchants in orange bubbles are more likely to be from the Tree-RNN+ (e.g., A−B+(TP)) cell, indicating that these more active merchants may be correctly recognized (e.g., captured) by the RNN, but missed by the Tree (e.g., the RNN outperforms the Tree on active merchants). In contrast, the less active merchants in blue bubbles are more likely to be from the Tree+RNN− (e.g., A+B−(TP)) cell, indicating the Tree outperforms the RNN in correctly recognizing less active merchants. The insights here may directly guide model selections based on the merchants' service frequency (e.g., active or not).

Referring again to FIG. 13, using LFD, the RNN (A) and GNN (B) are compared as shown in the bottom row of FIG. 13. Steps 1-4 of the comparison are conducted in a same or similar manner to the comparison of the Tree model and the RNN with the only difference being that a sample of the merchants (e.g., about 70K merchants from the 3.8M merchants) is used to reduce a cost of construction for the merchant graph.

At Step 5 of FIG. 13, several affinity-related meta-features are generated to probe the two models, because the experts expect the GNN to leverage the information from a merchant's neighbors more than the RNN. For example, the entropy of a merchant reflects how diverse its neighbors' category is. The n_connection denotes the degree of each merchant in the merchant graph. Using these new meta-features, the two discriminators of LFD are trained. As shown in FIG. 15, from the visualization at Step 6 of FIG. 13, it is found that entropy is a very differentiable meta-feature. When a merchant has more homogeneous neighbors (e.g., from the orange bubbles with larger entropy), the GNN tends to correctly capture the merchant, whereas the RNN is more likely to miss the merchant (e.g., the orange bubbles mostly fall into the RNN−GNN+ cell), which indicates that the GNN outperforms RNN on these merchants and the neighbors' information indeed contributes to the predictions. The observation here clearly reveals the value of affinity information between merchants, verifying the improvement proposed by the experts.

These two brief cases use prior knowledge on the compared models to derive meta-features. The models' behaviors on the meta-features, in turn, verify the experts' expectations. Note that one can still use the above meta-features to probe the behavior of the models, even if they have no prior knowledge about the models.

Insights: [CNN v.s. RNN]

This section presents deeper insights when comparing the CNN (A) and RNN (B) models using LFD. The insights go beyond what was known by the experts and deepen their understandings of the two models. The CNN and RNN have very similar performance and both capture the temporal behaviors of the merchants, but in different ways. One (the CNN) uses 1D convolutions, whereas the other (the RNN) employs the GRUs structure.

With respect to Steps 1-4 of FIG. 13, feeding the 3.8M merchants to the two models (e.g., two black boxes), two sets of scores are received, which are used to sort the merchants and identify the two sets of merchants captured by individual models (e.g., A+ and B+). Joining the two sets provides merchants in the three cells of the disagreement matrix (e.g., A+B+, A+B−, and A−B+). The disagreement matrix may be divided into two matrices of six cells based on the merchants' true category label (e.g., A+B+(TP), A+B−(TP), A−B+(TP), A+B+(FP), A+B−(FP), and A−B+(FP)).

With respect to Step 5 of FIG. 13, for the “learning” part of LFD, the merchants from the A+B−(TP) and A−B+(TP) cells are used to train the TP discriminator, and the merchants from A+B−(FP), A−B+(FP) are used to train the FP discriminator. In terms of meta-features, the 70 meta-features derived when comparing the Tree and RNN models may be used.

With respect to Step 6 of FIG. 13, and referring also to FIG. 15, at reference number a of FIG. 16, the more impactful or important meta-features to the TP and FP discriminators are shown, with each side ranked according to the overall metric described herein to compare the contribution of the same meta-feature to the TP and FP discriminators, and interpret the difference with as little as possible information. On the TP side (left), nonzero_numApprTrans ranks third and its detail is shown at reference number b of FIG. 16. The RNN correctly captures more when the merchants are relatively less-active (e.g., the blue bubbles on right are more likely to be CNN−RNN+), whereas the CNN correctly captures more when the merchants are very active in the time period of the past 2.5 years (e.g., the orange bubbles). With some analysis, the models' behavior matched the experts' expectations and the experts commented that the CNN has a limited receptive field (e.g., limited by the number of convolutional layers) and focuses more on local patterns, whereas the RNN can memorize longer history through its internal hidden states. When a merchant has a long and active history, there are rich local patterns as well, and the CNN outperforms the RNN. However, when the merchant is less active, the RNN performs better in capturing the sparser temporal behaviors. The same result with user interactions is shown at reference number c of FIG. 16 (e.g., by dragging the color control-points and brushing the legend, merchants that the RNN outperforms the CNN (e.g., merchants with approved transactions less than 730 days) can be easily identified. Using this meta-feature, LFD successfully reveals the subtle difference between the two models

Another meta-feature, mean_rateTxnAppr (ranked the second on the TP side), demonstrates the same trend, indicating that the RNN outperforms CNN in correctly identifying restaurants with low approval rates as well. In contrast, the mean_avgAmtAppr (ranked the first) shows an unnoticeable difference for the merchants on the two sides of the SHAP=0 line (the areas on both sides are in blue), implying this meta-feature cannot differentiate the two models. However, the large magnitude of this feature still makes it rank first.

On the FP side (FIG. 16, right), nonzero_numApprTrans ranks second, and the detail thereof is shown at reference number d of FIG. 16. All merchants here are non-restaurants but mis-captured as restaurants (e.g., FP), and the bubbles' pattern is reversed compared to that at reference b of FIG. 16 (e.g., the blue bubbles come to the left at reference number d of FIG. 16). The less-active merchants in blue bubbles are less likely to be mis-captured by the RNN, but more likely to be mis-captured by the CNN (e.g., from the CNN+RNN− cell of the FP side), indicating that the RNN still outperforms the CNN on merchants with sparser temporal behaviors.

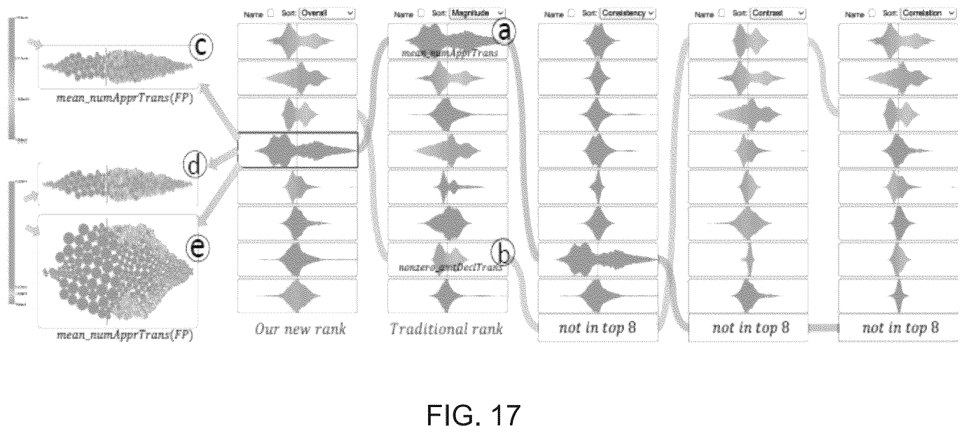

Different metrics in ranking the meta-features are also explored. FIG. 17 shows the top eight features ranked on the FP side. The meta-feature mean_numApprTrans shown at reference number a of FIG. 17 has the largest magnitude and it is identified as the most impactful or important meta-feature using the traditional order (e.g., mean(|SHAP|)). However, the meta-feature mean_numApprTrans ranks seventh in the consistency order and is not in the top 8 in the contrast and correlation orders (tracking the red curve). In contrast, the meta-feature nonzero_amtDeclTrans shown at reference number b in FIG. 17 (tracking the green curve) is the seventh most impactful or important in the magnitude list but has very large contrast and correlation values. Compared to the traditional Magnitude order, the Overall metric improves the rank of nonzero_amtDeclTrans (ranked the third) and decreases the rank of mean_numApprTrans (ranked the fourth), by considering multiple aspects of the meta-features to effectively rank meta-features from different perspectives and use the more important ones (e.g., more complementary ones) to improve model ensembling.

It is noted that the visual appearance of the area-plot and bubble-plot depends on the color mapping, which can be adjusted by the “transfer function” widget in the visualization interface. At reference number c of FIG. 17, the detailed view of mean_numApprTrans is shown with the default color legend. It can be seen that there are very few orange bubbles and their contribution to the aggregated color of the area-plot is unnoticeable. The color mapping may be changed as shown by the legend at reference number d in FIG. 17 to map a larger value range to orange. However, most of the bubbles are still in blue, and the feature still has a small contrast.

The layout and size of the bubbles can also be flexibly adjusted to reflect different levels of details for a meta-feature, which is demonstrated at reference numbers d and e of FIG. 17 by increasing the number of feature- and SHAP-bins when computing the 2D histogram (explained herein with respect to FIG. 10). For example, at reference number e of FIG. 17, more bins are used and the feature is presented in finer granularity, which also reflects that the accumulated area of the bubble-plot (e.g., the Detail part) cannot accurately present the data distribution and verifies the need of the area-plot (e.g., the Overview part).

CTR prediction is used to predict if a user will click an advertisement or not, which is a critical problem in the advertising industry. Avazu is a public CTR dataset, containing more than 40 million instances across 10 days. Each instance is an impression (e.g., advertisement view) and has 21 anonymized categorical features (e.g., site_id, device_id, etc.).

Using Avazu, a tree-based model (A, short for Tree) and an RNN model (B) are compared. Each model is trained to differentiate click from non-click instances. The following data partition was used in both models' training: Day 1: reserved to generate historical features; Days 2-8: used for model training; Day 9: used for model testing and comparison; and Day 10: held out for model ensembling experiments.

As the models may use some historical features (e.g., the number of active hours in the past day), Day 1 data is reserved for this purpose. Day 10 data is not touched and is left for later quantitative evaluation experiments. Note that, there are also works that partition Avazu by shuffling the 10 days of data and dividing them into folds. The manner in which partitioning data by time follows industrial practice and is more realistic (e.g., future data should not be leaked into the training process).

The Tree model takes individual data instances (e.g., advertisement views) as input, whereas the RNN connects instances into viewing sequences and takes them as input. The winning solution of the Avazu CTR Challenge is used to form the sequences. The details of individual models' training features and architectures are not needed, as LFD is feature-agnostic and model-agnostic. The final AUCs of the Tree and RNN are 0.7468 and 0.7396, respectively.

The initial steps are similar to those described in the earlier example cases herein. FIG. 8A shows the Disagreement Distribution view for this example case, from which it is known that the size of the disagreed instances from the TP side reaches the peak if the cutoff/threshold is between 15% to 20%. 15% is used as the cutoff to maximize the size of training data with the most disagreed predictions to present the distribution of data instances across the six cells of the two disagreement matrices (e.g., Step 4 of LFD as shown in FIG. 4) under different thresholds. Other cutoffs may be chosen based on the FP data distributions. However, in this case, TP instances are of more interest.

In Step 5 of LFD as shown in FIG. 4, meta-features from the raw data are generated in two steps. First, the Avazu raw data has 21 categorical features, and these features are extended by concatenating the categorical values of the features, e.g., device_id_ip is a feature combined from device_id and device_ip. Based on the experts' knowledge on the data, Avazu is extended to have 42 features (and feature combinations). Second, as CTR is the ratio between the number of clicks (n_clicks) and impressions (n_impressions) (e.g., CTR=n_clicks/n_impressions), meta-features are proposed by profiling the frequency of the 42 features from these three dimensions. For example, for the raw feature device_id, meta-feature n_clicks_device_id may be generated, denoting the number of clicks per device_id value. Also, as the RNN is not as good as the Tree (see the AUCs at Step 1), it is desirable to probe the sequence-related behaviors of the models. Thus, meta-features from a fourth dimension are generated to reflect the active level of the features (e.g., n_active_hours_*). In summary, generating meta-features from the 42 features in the following four dimensions, may provide 168 (42×4) meta-features. The meta-feature n_impressions_* denotes the number of impressions per value of * (where * represents one of the 42 features). •n_clicks_* indicates the number of clicks per value of *. •ctr_* denotes the CTR for each value of *. For example, if * is device_id and the CTR for a certain device is x, the value of ctr_device_id is x for all impressions that happened on this device. •n_active_hours_* reflects the number of hours (in the past day) that each value of * appeared in the data. Using the 168 meta-features, the TP and FP discriminators are trained to learn the difference between the Tree and RNN.

In Step 6 of LFD as shown in FIG. 4, after training, the meta-features from the TP and FP sides are ranked as shown in FIG. 8B. Meta-features n_active_hours_* never appear in the top differentiable ones, implying the RNN may not benefit more from the sequential information (compared to the Tree model). This insight provides clues to further diagnose the RNN to interpret the TP and FP discriminators to explain the impact of different meta-features on the captured and mis-captured instances.

After some analysis, the ML experts tend to believe that the relatively worse performance of RNN is originated from the data. First, there is no unique sequence ID in Avazu, and the solution to connect instances into sequences may not be optimal. Second, the sequence length is very short and the only 10 days of data may not be able to well capture behavior patterns of users. In contrast, in considering the CNN and RNN, 2.5 years of data are used and each merchant has a unique sequence ID. The presented visual evidence and analysis provide some explanations on why the RNN is not ranked as one of the top solutions for this CTR challenge.

From the TP side, as shown at reference number b₅ in FIG. 8B, ctr_site_id is a very differentiable feature. Although the RNN has a smaller AUC, the RNN outperforms the Tree model in capturing clicks when this meta-feature is large (e.g., the orange bubbles at reference number b₃ are more likely to be from the Tree-RNN+ cell, which makes sense as the RNN tends to remember the site visiting history). From the meta-features ordered by the Overall metric, other impactful or important features may be easily identified. For example, the meta-feature ctr_site_app_id (ranked second) denotes the CTR of the feature combined from site_id and app_id. The meta-feature ctr_site_app_id shows the same trend with the meta-feature ctr_site_id (e.g., the RNN behaves better than the Tree model if an impression is from the site-application paired with a higher click rate). The meta-feature ctr_c14 (ranked third) is another impactful or important meta-feature. The RNN may be more accurate in capturing clicks when this feature has small values (e.g., indicated by the blue area to the right at reference number b₇ of FIG. 8B). Although c14 is unknown (e.g., an anonymized raw feature of Avazu), it can be inferred that it is an impactful or important click-related feature from LFD.

For the FP side as shown at reference number b₅ of FIG. 8B, the meta-feature ctr_site_id is also the most impactful or important (with reference number b₄ tracking the curves between the two meta-feature lists). The behavior of the meta-feature ctr_site_id is consistent to the TP side shown at reference number b₂ (e.g., orange regions are still on the right, indicating the RNN tends to mis-capture instances if the value of ctr_site_id is large. In contrast, the feature nonzero_numApprTrans shows reversed patterns from the TP and FP sides at reference numbers b and d of FIG. 16, which reveals a potential bias of the model (e.g., the RNN here tends to give high scores to instances with large ctr_site_id, whether the instances are real click instances or not). After thoroughly examining and comparing the two cases, it is found that the observation actually reflects different signal strengths of the merchant category verification and CTR problems.

The signal strength of a dataset reflects how distinguishable the positive instances are from the negative ones. For merchant category verification, the signal strength is strong (e.g., merchants with falsified categories have certain on-purpose behaviors that regular merchants cannot accidentally conduct). However, for CTR, the signal strength is much weaker. Randomness widely exists when users choose to click an advertisement or not. As a result, two records with very similar values across all features may have different click labels. Consequently, instances from the A−B+(TP) and A−B+(FP) cells are similar to some extent, so as to the instances from the A+B−(TP) and A+B−(FP) cells. In turn, the trained TP and FP discriminators behave similarly (due to their similar training data), which explains the similar patterns of ctr_site_id on the TP and FP sides as shown at reference number b₂ in FIG. 8B.

### Evaluation

The model comparison and feature analysis results described herein may be evaluated through both quantitative and qualitative evaluations. For the quantitative part, the more impactful or important meta-features may be identified when comparing two models through LFD, used to ensemble the models through FWLS, and used to validate the efficacy of LFD through the improved ensembling result. For the qualitative part, the comparison results are confirmed with ML experts who have thorough knowledge of the models for sanity checks (in the case studies) and open-ended interviews to collect the experts' feedback are conducted.

As previously explained herein, FWLS ensembles models by considering the behaviors of the models in different features. What features should be used in FWLS is a critical problem and the ensembling result can quantitatively reflect the quality of the used features. The top 15 meta-features ranked by the five metrics of LFD may be used to generate five FWLS models, and compare their AUCs to quantify the rankings' quality.

Two state-of-the-art and publicly available CTR models may be used to conduct this LFD experiment. One is the logistic regression (LR) implemented by “follow the proximally regularized leader (FPRL-Proximal)” as described by H. B. McMahan, G. Holt, D. Sculley, M. Young, D. Ebner, J. Grady, L. Nie, T. Phillips, E. Davydov, D. Golovin et al., in the paper titled “Ad click prediction: a view from the trenches,” in Proceedings of the 19th ACM SIGKDD international conference on Knowledge discovery and data mining, 2013, pp. 1222-1230, the entire contents of which are incorporated by reference. The other is the “feature interactiongraph neural network” (Fᵢ-GNN, short for GNN) as described by Z. Li, Z. Cui, S. Wu, X. Zhang, and L. Wang, in the paper titled “Fᵢ-gnn: Modeling feature interactions via graph neural networks for ctr prediction,” in Proceedings of the 28th ACM International Conference on Information and Knowledge Management, 2019, pp. 539-548, the entire contents of which are incorporated by reference. Both models are trained using the 21 raw features of Avazu (Days 2-8).

Using scores of the two models, data instances (e.g., test data from Day 9) are sorted, the data instances in the LR+GNN− and LR−GNN+ cells are identified (Step 3), and a discriminator is trained to differentiate the data instances using the 168 meta-features introduced herein. Note that, Step 4 of LFD is not needed here, because a single order of meta-features considering both TP and FP instances is used (e.g., there is no need to separate the TP and FP instances).

After getting the discriminator, the five metrics described herein are used to rank the 168 meta-features into five different orders, and top 15 meta-features from each order are selected to conduct the FWLS. As a result, there are five ensemble models. These models are each trained based on Day 9 data (to fit the best values of w₁ and w₂), and the ensembling performance is tested on both Day 9 and Day 10 data.

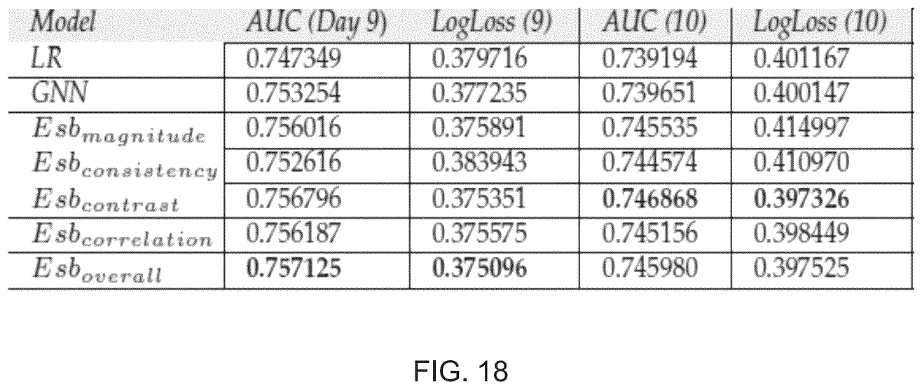

FIG. 18 is a table that shows the performance of the original and ensembled models. There are three findings. First, all five ensembled models (using the top 15 meta-features ranked by different metrics) achieve better performance than the original LR and GNN, reflecting the efficacy of FWLS. Second, for both Day 9 and Day 10 data, Esbₒᵥₑᵣₐₗₗ is better than Esb_{magnitude}, indicating the Overall metric that profiling features' impact or importance from multiple perspectives is better than the traditional Magnitude metric (e.g., mean(|SHAP|)). The impactful or important meta-features in the model comparison context are those that maximally differentiate the two models (e.g., the most complementary ones). Being able to identify these validates the efficacy of LFD. Third, for Day 10 data, Esb_{contrast} generates the best performance. This is reasonable as Contrast reflects the complementary-level the most. The result also indicates that the weights in our Overall metric (Eq. 6) may need to be adjusted for different datasets.

Multiple case studies were conducted with the ML experts (E1-E5) using LFD. The four merchant category verification models described herein are proposed by the experts and they have sufficient knowledge on their differences. As a sanity check, the insights derived from LFD match well with the experts' expectations, e.g., the RNN is better than the Tree in capturing temporal behaviors, and the affinity information helps the GNN outperform the RNN. The comparison result of CTR models also makes sense to the experts and the proposed meta-features (e.g., n_active_hours_*) help to reveal the corresponding RNN's deficiency. The studies were concluded with open-ended interviews, in which the experts' feedback was collected.

In general, all experts were impressed to see that LFD can effectively verify their assumptions on different models. E1 liked the idea a lot and considered LFD as an “offline adversarial learning” (e.g., in analogy to the online adversarial learning of generative adversarial networks (GANs)), where the two compared models explicitly identify where to learn and the discriminator is similar to the discriminator of GAN. This expert also identified the advantage of LFD in “smartly avoiding the data imbalance issue”. E2 has decades of experience in model building and feature engineering. This expert commented “as a model designer, the feature order is extremely important” and appreciated the feature-ordering metrics introduced. This expert also believed that proposing new meta-features is a “good and intuitive” way to “probe the behaviors of the compared models”. The insights from LFD inspired him to revisit early works that filter instances by a model's score and use the filtered ones to further improve another model. E4-E5 are frontline ML practitioners, working with ML models in production. They especially liked the interactivity of the system in ranking meta-features and the efficacy of LFD in identifying the complementary ones for model ensembling.

There were also some desired features for LFD and the system. For example, other feature interpretation methods may be integrated into LFD and the framework may be made more general. Negative side comparisons may also be enabled (e.g., comparing true-negative and false-negative instances by sorting instances increasingly at Step 2) to extend LFD. The precision of the two compared models at different thresholds may also be provided in the Disagreement Distribution view.

Although non-limiting embodiments or aspects of the present disclosure focus primarily on positive predictions (e.g., TP and FP instances) of the two compared classifiers, and thus, the instances are at least captured by one model, they are not limited thereto and two classifiers may be compared from the negative predictions (e.g., sorting the scores increasingly at Step 2 of LFD). It is also noted that the A−B− (as well as the A+B+) cell may be of less interest for the purpose of comparison, because it is where the two classifiers agree on, and there is no disagreement to learn from.

LFD may depend on SHAP as to the interpretation accuracy. Consequently, LFD may have an inherent limitation on cases where SHAP cannot provide accurate interpretations. For this limitation, two points are noted. First, SHAP is widely applicable to most ML models and comes with solid theoretical supports. Therefore, considerably inaccurate interpretations are not expected to occur very often. Second, as the six steps of LFD have been very well modularized, SHAP may be easily replaced with other interpretation methods at Step 6 (e.g., the recently proposed influence function as described by P. W. Koh and P. Liang, in the paper titled “Understanding black-box predictions via influence functions,” in International Conference on Machine Learning. PMLR, 2017, pp. 1885-1894, the entire contents of which are incorporated by reference).

There may be two scalability related concerns of LFD. First, LFD may be limited to the comparison of binary classifiers only due to the focus of industrial problems. For multi-class classifiers, only their difference on a single class may be compared at a time. Second, the system currently supports hundreds of meta-features, e.g., 168 in the CTR case. However, for cases with thousands of meta-features, the visualization may not scale well. Fortunately, using the proposed feature importance metrics, less important features may be eliminated from visualization to reduce the visualization cost. Additionally, the computation of SHAP values may also be a bottleneck. However, SHAP values may be computed offline and/or other more efficient model interpretation methods may be used for a replacement.

LFD may be useful from at least two perspectives. First, LFD may provide feature-level interpretations in the context of comparing two classifiers, providing actionable insight into model selections. As described herein, many model interpretation works exist for individual classification models. However, existing works fail to focus on comparatively interpreting two classifiers, distinguishing LFD from the existing works. By learning from the disagreed instances, LFD can expose subtle differences between two models. For example, the insight that the RNN performs better on merchants with sparser temporal history may be very useful for frontline ML practitioners to select models. Second, LFD provides more effective metrics in prioritizing meta-features, leading to better model ensembling. As explained, the importance of features is often measured by their contribution Magnitude, which depicts an impact or importance of features from one perspective only. The Overall metric profiles features from multiple perspectives and could more comprehensively reflect an impact or importance of features.

The six steps of LFD described herein are well modularized, making the comparison and analysis semi-automated. For example, Steps 1-4 may be conducted through a Python script with several parameters. The meta-feature proposing at Step 5 is the only part that uses customized input of users, and may become cumbersome for novice users. In practice, however, the frontline ML practitioners usually have a list of meta-features at hand (based on their assumptions and domain knowledge on the compared models). So, this step is not very complicated for them either. The visual designs at Step 6 are based on the traditional summary-plot and the interactions only involve some basic operations, e.g., ordering and brushing. According to the feedback from the ML experts, the visual designs are not hard to comprehend and the interactions are intuitive to them.

Accordingly, non-limiting embodiments or aspects of the present disclosure provide LFD, a model comparison, and visualization framework, that compares two classification models by identifying data instances with disagreed predictions, and learns from the disagreement using a set of proposed meta-features. Based on the SHAP interpretation of the learning process, especially the models' preference on different meta-features, the fundamental difference between the two compared models may be interpreted. Multiple metrics to prioritize the meta-features from different perspectives are also provided. The prioritized features disclose the complementary behaviors of the compared models and can be used to better ensemble them. Through qualitative case studies with ML experts and quantitative evaluations on model ensembling, the efficacy of LFD is validated.

In some non-limiting embodiments or aspects, model comparison system 102 may identify, based on the relative success rate, a weak point in one of the first ML model and the second ML model. As an example, model comparison system 102 may identify, based on the first success rate and the second success rate, a weak point in the second ML model associated with a first portion of samples of the plurality of samples including a same first value for a same first feature of the plurality of features and for which the first success rate associated with the first ML model is different than (e.g., greater than, less than, etc.) the second success rate associated with the second ML model. As an example, model comparison system 102 may identify, based on the first success rate and the second success rate, the weak point in the second ML model associated with a second portion of samples of the plurality of samples including a same second value for the same first feature of the plurality of features and for which the first success rate associated with the first ML model is different than (e.g., less than, greater than, etc.) the second success rate associated with the second ML model.

A same feature of the plurality of features may include any feature associated with a sample (e.g., any feature associated with a transaction sample, etc.), such as a transaction parameter, a metric calculated based on a plurality of transaction parameters associated with a plurality of transactions, and/or one or more embeddings generated therefrom. For example, the same feature may include transaction amount, transaction date and/or time, type of products and/or services associated with the transaction, type of currency, merchant type, merchant name, merchant location, MCG, MCC, and/or the like. As an example, a same value for the same feature may include a same merchant location (e.g., a same merchant country, etc.), such as each transaction sample being associated with a merchant location including a value of “Brazil”, and/or the like. In such an example, model comparison system 102 may identify, based on the first success rate and the second success rate, the weak point in the second ML model as a merchant location in Brazil based on identifying that the first success rate associated with the first ML model is greater than the second success rate associated with the second ML model for the transaction samples having a merchant location in Brazil.

In some non-limiting embodiments or aspects, the first subset of features for the first ML model is different than the second subset of features for the second ML model, and model comparison system 102 may identify the weak point in the second ML model by: determining a difference in features between the first subset of features and the second subset of features; selecting, based on the same first feature included in the first portion of samples and the difference in features, one or more features of the plurality of features; adjusting the second subset of features based on the selected one or more features; and generating, using the adjusted second subset of features, an updated second ML model. For example, model comparison system 102 may identify a weak point in the second ML model as transaction samples having a same value for a same merchant location (e.g., transaction samples having a merchant location in Brazil, etc.), and model comparison system 102 may select, according to the difference in the features between the first subset of features and the second subset of features (and/or one or more predetermined rules linking input features, etc.), one or more features (e.g., new features, different features, etc.) to add to the second subset of features or to replace one or more second features in the second subset of features to use in generating an updated version of the second ML model to improve the performance of the second ML model in predicting transaction samples having the same value for the same feature (e.g., a merchant location in Brazil, etc.) identified as the weak point in the second ML model.

In some non-limiting embodiments or aspects, a first set of hyperparameters for a ML algorithm used to generate the first ML model is different than a second set of hyperparameters for a same ML algorithm used to generate the second ML model, and model comparison system 102 may identify the weak point in the second ML model by: determining a difference in hyperparameters between the first set of hyperparameters and the second set of hyperparameters; determining, based on the same first feature included in the first portion of samples and the difference in the hyperparameters, one or more hyperparameters; adjusting the second set of hyperparameters based on the selected one or more hyperparameters; and generating, using the adjusted second set of hyperparameters, an updated second ML model. For example, model comparison system 102 may identify a weak point in the second ML model as transaction samples having a same value for a same merchant location (e.g., transaction samples having a merchant location in Brazil, etc.), and model comparison system 102 may determine, according to the difference in the hyperparameters between the first set of hyperparameters and the second set of hyperparameters (and/or one or more predetermined rules linking hyperparameters to features, etc.), one or more hyperparameters (e.g., new hyperparameters, different hyperparameters, etc.) to adjust in the second set of hyperparameters to use in generating an updated version of the second ML model to improve the performance of the second ML model in predicting transaction samples having the same value for the same feature (e.g., a merchant location in Brazil, etc.) identified as the weak point in the second ML model.

A goal of LFD is to gain insights that enable business partners and modelers to have a deep understanding of a model. Insights should be actionable: business partners should be able to use these insights to convince potential clients to adopt a new model, and modelers should be able to use these learned insights to improve their models.

Insights can be learned and presented using various forms, for example, by revealing problems and suggesting feasible solutions as described by Zachary C. Lipton and Jacob Steinhardt in the paper entitled “Troubling trends in machine learning scholarship”, arXiv preprint arXiv:1807.03341 (2018), and by Maurizio Ferrari Dacrema, Paolo Cremonesi, and Dietmar Jannach in the paper entitled “Are we really making much progress? A worrying analysis of recent neural recommendation approaches”, arXiv preprint arXiv:1907.06902v3 (2019), the entire contents each of which are incorporated by reference.

Non-limiting embodiments or aspects of the present disclosure may approach this problem from a feature analysis/recommendation perspective. For example, model comparison system 102 may create a large feature poll, known as “oracle features” as described by Stefanos Poulis and Sanjoy Dasgupta in the paper entitled “Learning with feature feedback: from theory to practice”, In Proceedings of the 20th International Conference on Artificial Intelligence and Statistics (2017) at pages 1104-1113, the entire contents of which are incorporated by reference. Model comparison system 102 may investigate which of these features contribute to the disagreement between two models at a given operating point, which recognizes that, if a feature (or a set of features) has the ability to discriminate those disagreed instances, this feature carries information that is overlooked in the features used in one of the current two models or in each of the models. As an example, the available features in one of the current two models or in each of the models cannot support reliable differentiation between classes, and thus cause the disagreements. Incorporating this new feature into the two models provides new discriminative power to one of the models or both models, and thus helps mitigate the disagreements.

Model comparison system 102 may create oracle features based on an understanding on the data and years of domain knowledge. For example, model comparison system 102 may use automatic tools as disclosed by: (i) James Max Kanter and Kalyan Veeramachaneni in the paper entitled “Deep feature synthesis: Towards automating data science endeavors” In IEEE International Conference on Data Science and Advanced Analytics (DSAA) (2015) at pages 1-10; (ii) Gilad Katz, Eui Chul, Richard Shin, and Dawn Song in the paper entitled “ExploreKit: Automatic feature generation and selection” In International Conference on Data Mining (2016) at pages 979-984; and/or (iii) Yuanfei Luo, Mengshuo Wang, Hao Zhou, Quanming Yao, WeiWei Tu, Yuqiang Chen, Qiang Yang, and Wenyuan Dai in the paper entitled “AutoCross: Automatic feature crossing for tabular data in real-world applications” arXiv preprint arXiv:1904.12857 (2019), the entire contents of each of which are incorporated by reference, and/or by discovering strong discriminative features through understanding properties of the data that distinguish one class from another, disclosed by Kayur Patel, Steven M. Drucker, James Fogarty, Ashish Kapoor, and Desney S. Tan in the paper entitled “Using multiple models to understand data” In Proceedings of the Twenty-Second International Joint Conference on Artificial Intelligence (2011), the entire contents of which are incorporated by reference.

To see which oracle features contribute most to the disagreement at a given point, model comparison system 102 may train two XGBoost trees, one on instances in Group Z1 and Group Y1, and another on instances in Group Y2 and Group Z2 as described by Junpeng Wang, Liang Wang, Yan Zheng, Chin-Chia Michael Yeh, Shubham Jain, and Wei Zhang in the paper entitled “Learning-from-disagreement: A model comparison and visual analytics framework” submitted to IEEE Transactions on Visualization and Computer Graphics, the entire contents of which are incorporated by reference, and rank feature impact magnitude or importance based on their SHAP values as described by Scott M. Lundberg and Su-In Lee in the paper entitled “A unified approach to interpreting model predictions, Advances in Neural Information Processing Systems” (2017) and by Scott M. Lundberg, Gabriel G. Erion, and Su-In Lee in the paper entitled “Consistent individualized feature attribution for tree ensembles” arXiv preprint arXiv:1802.03888 (2018), the entire contents of each of which are incorporated by reference. Because XGBoost trees need all of the features to be numerical, all categorical features are converted into numerical features using some feature encoding mechanism (e.g., historic click-through rate from a publisher's website, historic decline rate from a merchant, etc.).

Non-limiting embodiments or aspects of the present disclosure provide an alternative method to measure the discriminative power of a feature, without the need to train a model. This method, which may be referred to as robust information value (RIV), removes two major flaws from the traditional information value (IV) used in the credit card industry as described by Naeem Siddiqi in the paper entitled “Credit Risk Scorecards: Developing and Implementing Intelligent Credit Scoring”, John Wiley & Sons, Hoboken, New Jersey (2016), the entire contents of which are incorporated by reference. Given that LFD analyzes disagreed instances at a given score cutoff based on a large number of oracle features, and the given score cutoff can vary for different clients, RIV greatly speeds up the process of discovering impactful or important features that cause the disagreement.

Traditionally, IV is calculated according to the following Equations (10) and (11):

$${WOE}_{i} = log ( \frac{{E}_{i}}{{NE}_{i}} ) - log ( \frac{E}{NE} ) \qquad ( 10 )$$

$$IV = {\sum }_{i = 1}^{C} [ ( \frac{{E}_{i}}{E} - \frac{{NE}_{i}}{NE} ) \times {WOE}_{i} ] \qquad ( 11 )$$

where C is the number of categories in a feature, Eᵢ is the number of events in category i, NEᵢ is the number of non-events in category i, E is the total number of events, and NE is the total number of non-events.

Equation (10) refers to weigh-of-evidence (WOE). A basic property of WOE can be thought of as the average of the whole population. For example, WOE may indicate that a final belief in a hypothesis (e.g., a click is correctly classified by Model A but not by Model B) is equal to an initial belief plus the weight of evidence of whatever evidence is presented. As an example, a final belief that a click is correctly classified by Model A but not by Model B may equal to an initial belief that any click may be correctly classified by Model A but not by Model B, plus the weight of evidence, such as its occurrence in a site-ID where Model A performs better than Model B based on training data.

WOE can be positive, negative, or zero. Positive WOE causes a belief, in the form of log-odds, to increase; negative WOE results in a decrease in a belief; and a WOE of zero leaves the log-odds unaffected.

Consider Group Z1 and Y1, where instances in Group Z1 have a label 0, and instances in Group Y1 have a label 1. The oracle feature is Site-ID which itself may include hundreds of site-IDs (categories). If a click occurs in a site-ID whose WOE value is 0.60, this is interpreted as evidence of 0.60 for this click belonging to Group Z1 (that is, there is more evidence to indicate that this instance is correctly classified by model A but not by model B, compared with before the site-ID where the click occurs is known). If, however, the click occurs in a site-ID whose WOE value is −0.58, this is interpreted as evidence of 0.58 against this click belonging to Group Z1.

After obtaining WOE, the calculation of information value (IV) in Equation (11) is straightforward. Notice that IV is non-negative because the sights of Eᵢ/E−NEᵢ/NE and WOEᵢ are the same. WOE and IV are widely used in the credit scoring industry and provide a simple yet powerful way of making sense of a feature. WOE is recently used in a prediction difference analysis method for visualizing the response of a deep neural network for a given input.

There are two flaws in the traditional WOE and IV formulas. The first flaw is that they treat categories in a feature equally, ignoring the fact that small counts can lead to less robust statistics. For instance, for the Site-ID feature, suppose one site-ID has one click and two non-clicks, while another site-ID has 100 clicks and 200 non-clicks. Both site-IDs have a click rate of 0.5, but there is less confidence in the click rate of the first site-ID than that in the second site-ID. The second flaw is that IV has a bias toward giving a higher value for features including more categories. Because each element on the right side of Equation (11) can never have a negative value, adding a large number of elements each having a tiny value can lead to a larger sum.

Non-limiting embodiments or aspects of the present disclosure overcome these two flaws by introducing the following new formulas, inspired by the m-estimate method for probability estimate, according to the following Equations (12) and (13):

$${RWOE}_{i} = log ( \frac{{E}_{i} + m \times \frac{E}{E + NE}}{{NE}_{i} + m \times \frac{NE}{E + NE}} ) - log ( \frac{E}{NE} ) \qquad ( 12 )$$

$$RIV = {\sum }_{i = 1}^{C} [ ( \frac{{E}_{i} + m \times \frac{E}{E + NE}}{E} - \frac{{NE}_{i} + m \times \frac{NE}{E + NE}}{NE} ) \times {WOE}_{i} ] \qquad ( 13 )$$

where m is a smoothing parameter. These two formulas may be referred to as robust weight-of-evidence (RWOE) and robust information value (RIV), respectively.

An idea of RWOE and RIV may be that, in each category of a feature, m*(E/(E+NE) events and m*(NE/(E+NE) non-events are “borrowed”, given that E/(E+NE) and NE/(E+NE) actually represent event rate and non-event rate, respectively. How many events and non-events that are borrowed may depend on a confidence in the events and non-event counts in a category. If the counts are small (e.g., fail to satisfy a threshold, etc.), more events and non-events may be borrowed by setting a larger m, or vice-versa. A very large m may make the first part on the right side of Equation (12) become log(E/NE), leading to a zero WOE value (e.g., the global average WOE, which is zero). As a result, this category may not contribute anything to the IV calculation of this feature, which effectively mitigates the bias exhibited in the traditional IV formula.

Notice that WOE and IV are for a single feature. It is well realized that features that look irrelevant in isolation may be relevant in combination. This is especially true in CTR prediction and transaction anomaly detection where the strongest features indicative of the event being classified are those that are best capturing interactions among several dimensions. A majority of oracle features may be designed for capturing interactions. Because these features often involve several dimensions (e.g., the concatenation of User-ID, Site-ID, and Advertiser-ID may result in a three-dimensional feature), many categories in these features tend to have small counts.

### Example Application Case 1: CTR Prediction

LFD may always be working on a pair of models. In this application case, the pair of models consist of a logistic regression model and a graph neural network model known as a feature interaction graph neural network (FiGNN). The logistic regression model, named Model A, includes 21 raw features, which are encoded using “hash trick” one-hot encoding, and is trained using the follow the regularized leader (FTRL) online learning algorithm. The graph neural network model, named Model B, uses a novel graph structure aiming at capturing feature interactions from the 21 raw features automatically.

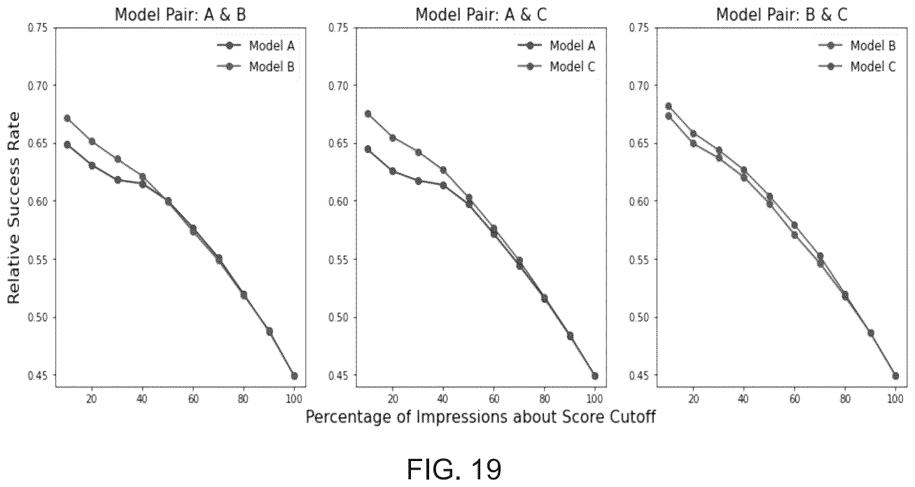

Model A may be viewed in this pair as a simpler model because it is a linear model including only 21 raw features, and Model B is a more advanced model because it has a more complex structure designed for discovering feature interactions automatically. Referring now to FIG. 19, which is a graph showing relative success rates of example models, the left panel of FIG. 19 shows the relative success rate of this pair of models. An interesting observation is that, as the penetration goes deeper, the advantage of FiGNN over the simple logistic regression model vanishes. This suggests that, if access to a large audience is desired, it does not matter whether a simple or an advanced model should be used. A benefit of using a more advanced model comes from working on the population with high scores, as often the case for CTR prediction and transaction anomaly detection.

Also referred to in FIG. 19 is a logistic regression model, named Model C, which is trained using 70 features recommended by the LFD framework with FTRL. Again, the features are encoded using “hash trick” one-hot encoding. It can be seen that Model C offers noticeable improvements compared with both Model A (middle panel) and Model B (right panel), especially for the high-score population.

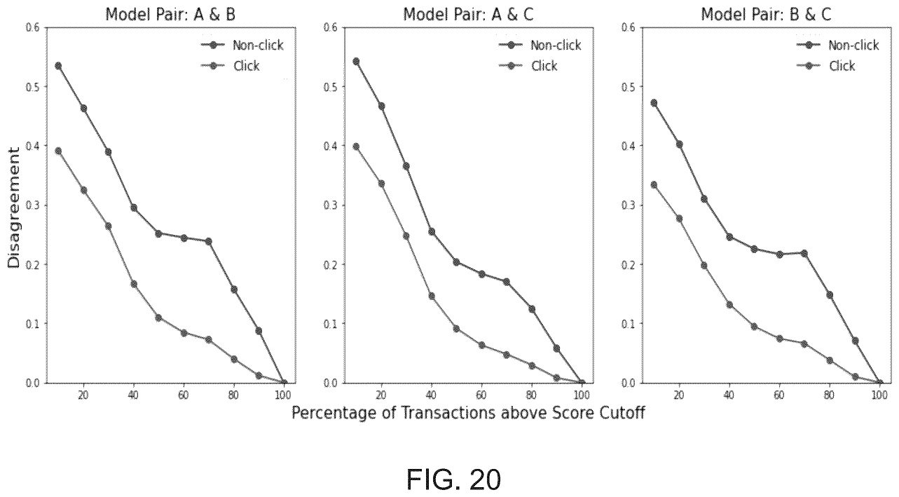

Referring now to FIG. 20, which is a graph showing disagreements between example models, FIG. 20 shows disagreements on true positives (clicks) and false positives (non-clicks) among three models. There are two interesting findings from FIG. 20. A first finding is that disagreements on false positives (blue lines) are much more serious than disagreements on true positives (red lines). This finding raises the following question: in CTR prediction, or event prediction in general, all current efforts are focused on identifying events. Should efforts to identify non-events, that is, try to reduce false positives also be made? The second finding is that Model C, trained using 70 features recommended by LFD, has less disagreements with Model B in both true positives and false positives at the high-score regions (refer to right panel), compared with Model A (refer to middle panel), even though Model A and Model B have similar architecture (both are logistic regression models).

Table 1 below shows the AUC from the three models in FIG. 20.

TABLE 1

| | Training | | OOT | |
|---|---|---|---|---|
| Model/Performance | AUC | LogLoss | AUC | LogLoss |
| Model A | 0.7569 | 0.3936 | 0.7431 | 0.3991 |
| Model B | 0.7932 | 0.3710 | 0.7470 | 0.3989 |
| Model C | 0.7857 | 0.3767 | 0.7530 | 0.3953 |

Table 2 below presents the top 20 features recommended by LFD based on two types of disagreements from Model A and Model B, disagreements on true positives (refer to left panel), and disagreements on false positives (refer to middle panel). It is interesting to notice that these two sets of features are pretty much in agreement. Also included in the table are the top 20 features from the agreed instances (refer to the right panel). These are instances either correctly classified by both models (TPAB) or incorrectly classified by both models (FPAB). Intuitively, it is very hard to differentiate instances in TPAB from instances in FPAB. This is indeed the case: the IV values in the right panel all have a smaller value, indicating the signals used to separate these two populations are very weak.

TABLE 2

| TP_{A} vs TP [symbol] | | FP_{A} vs FP_{B} | | TP_{AB} vs FP_{AB} | |
|---|---|---|---|---|---|
| [symbol] _ [symbol] _ [symbol] 17 | 4. [symbol] | [symbol] _ [symbol] _ [symbol] | 4. [symbol] 0 | [symbol] _ [symbol] _ [symbol] _ [symbol] | 0.2 [symbol] |
| [symbol] _ [symbol] _ [symbol] 14 | 3. [symbol] | [symbol] _ [symbol] _ [symbol] 14 | [symbol] 80 [symbol] | [symbol] _ [symbol] _ [symbol] _ [symbol] 14 | 0. [symbol] |
| [symbol] _ [symbol] | [symbol] | [symbol] _ [symbol] _ [symbol] _ [symbol] | 4. [symbol] | [symbol] _ [symbol] _ [symbol] _ [symbol] | 0.27 [symbol] 388 |
| [symbol] _ [symbol] _ [symbol] | [symbol] 0 [symbol] | [symbol] _ [symbol] _ [symbol] _ [symbol] 21 | 4. [symbol] | [symbol] _ [symbol] _ [symbol] _ [symbol] | 0.2 [symbol] 7 [symbol] 3 |
| [symbol] _ [symbol] 17 | [symbol] 0 [symbol] | [symbol] _ [symbol] _ [symbol] _ [symbol] | 4. [symbol] | [symbol] _ [symbol] _ [symbol] _ [symbol] | 0.2 [symbol] 74 |
| [symbol] _ [symbol] 14 | [symbol] | [symbol] _ [symbol] _ [symbol] _ [symbol] | 4. [symbol] | [symbol] _ [symbol] _ [symbol] | 0. [symbol] |
| [symbol] _ [symbol] _ [symbol] _ [symbol] | [symbol] 0 [symbol] | [symbol] _ [symbol] _ [symbol] | 4.0 [symbol] | [symbol] _ [symbol] | 0.2 [symbol] |
| [symbol] _ [symbol] 14 | [symbol] | [symbol] _ [symbol] 17 | 4. [symbol] | [symbol] _ [symbol] | [symbol] |
| [symbol] _ [symbol] _ [symbol] _ [symbol] 17 | [symbol] .82 [symbol] | [symbol] _ [symbol] | [symbol] | [symbol] _ [symbol] _ [symbol] | 0.240 [symbol] |
| [symbol] _ [symbol] _ [symbol] _ [symbol] | [symbol] | [symbol] _ [symbol] _ [symbol] | [symbol] | [symbol] _ [symbol] _ [symbol] | 0. [symbol] |
| [symbol] _ [symbol] _ [symbol] _ [symbol] | [symbol] | [symbol] _ [symbol] _ [symbol] | 3. [symbol] | [symbol] _ [symbol] _ [symbol] _ [symbol] | 0. [symbol] 33 |
| [symbol] _ [symbol] _ [symbol] | [symbol] | [symbol] _ [symbol] 17 | [symbol] | [symbol] _ [symbol] _ [symbol] _ [symbol] 21 | 0.23 [symbol] |
| [symbol] _ [symbol] _ [symbol] | [symbol] | [symbol] _ [symbol] 14 | [symbol] 010 | [symbol] _ [symbol] _ [symbol] _ [symbol] | 0. [symbol] |
| [symbol] _ [symbol] _ [symbol] | [symbol] | [symbol] _ [symbol] _ [symbol] | 3. [symbol] | [symbol] | 0. [symbol] |
| [symbol] _ [symbol] _ [symbol] | 3.27 [symbol] | [symbol] _ [symbol] _ [symbol] | 3. [symbol] 10 [symbol] | [symbol] _ [symbol] _ [symbol] _ [symbol] 7 | 0.23 [symbol] 0 [symbol] |
| [symbol] _ [symbol] _ [symbol] | 3.1 [symbol] | [symbol] _ [symbol] _ [symbol] _ [symbol] 14 | [symbol] | [symbol] _ [symbol] | 0. [symbol] |
| [symbol] _ [symbol] _ [symbol] | [symbol] 44 | [symbol] _ [symbol] _ [symbol] | [symbol] | [symbol] _ [symbol] | 0. [symbol] |
| [symbol] _ [symbol] | 2.84 [symbol] | [symbol] _ [symbol] _ [symbol] | [symbol] | [symbol] _ [symbol] _ [symbol] 14 | 0. [symbol] |
| [symbol] _ [symbol] | [symbol] | [symbol] _ [symbol] | [symbol] 498 | [symbol] | 0.221780 |
| [symbol] _ [symbol] _ [symbol] _ [symbol] 14 | 2.793777 | [symbol] | [symbol] | [symbol] _ [symbol] _ [symbol] | 0.220 [symbol] 0 [symbol] |

[symbol]

indicates data missing or illegible when filed

### Example Application Case 2: Anomaly Detection

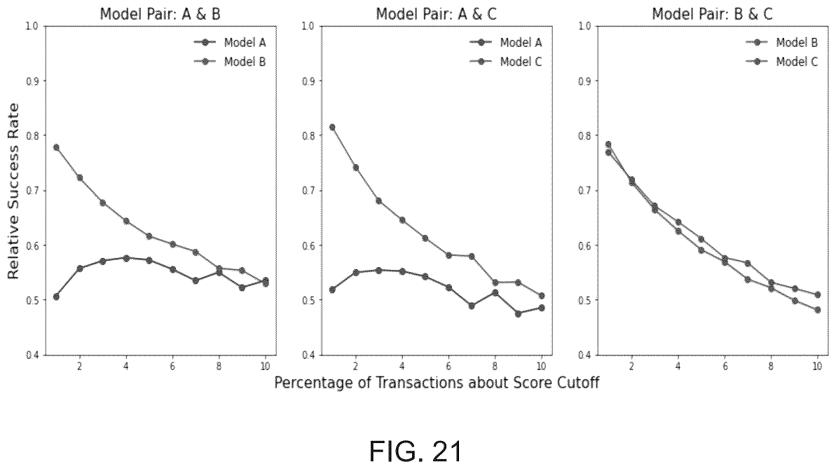

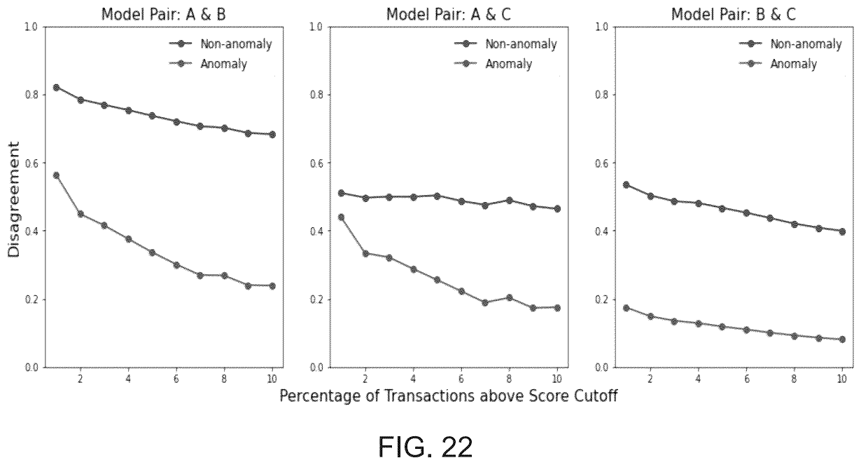

The pair of models used in this application is a gradient boosting tree model and a RNN model, unlike in Example Application Case 1, shown is the predictive power from features recommend by LFD. What is demonstrated in this application case is that LFD helps to understand how the ensemble works when the gradient boosting tree model and the RNN model are ensembled. FIG. 21, which is a graph showing relative success rates between example models, shows the gradient boosting tree model, named Model A, the RNN model, named Model B, and the ensemble, named Model C. FIG. 22, which is a graph showing disagreements between example models, in particular, shows disagreements on true positives (anomalies) and false positives (non-anomalies) among the three models.

An interesting finding is from the middle panel and right panel: Ensemble reduces disagreement more on the gradient boosting tree model on false positives (refer to blue curve in the middle panel), and in the meantime reduces disagreement more on RNN on true positives (refer to red curve in the right panel). Notice in the above analysis, the ensemble weights are set as 0.5 for both models. This is on purpose because it enables seeing if the ensemble works if two model scores are treated equally.

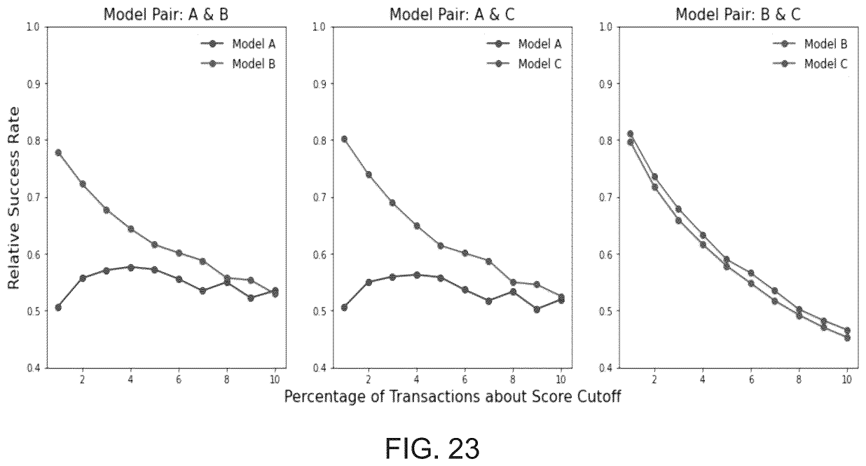

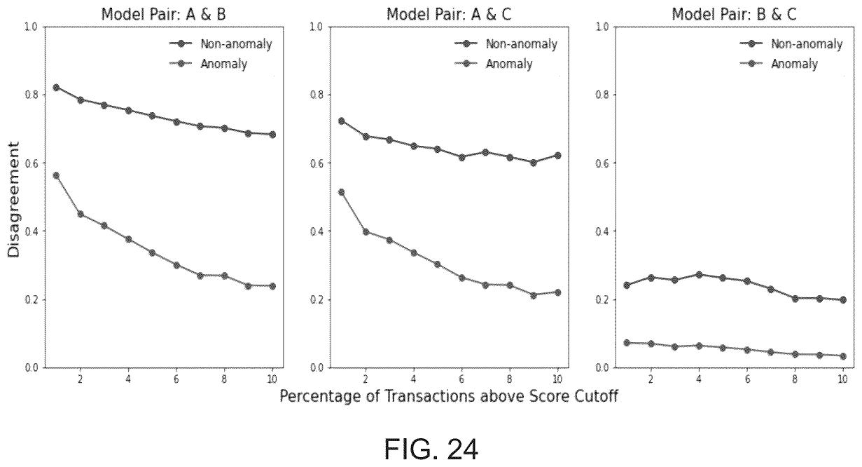

As a comparison, FIGS. 23 and 24 include graphs showing the relative success rate curves and disagreement curves when we apply a weight 0.2 to the gradient boosting tree model and a weight 0.8 to the RNN model.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

1. A system for comparing machine learning models, the system comprising:
at least one processor programmed or configured to:
receive a dataset of data instances, wherein each data instance comprises a feature value for each feature of a plurality of features;
generate outputs of a first machine learning model and outputs of a second machine learning model based on the dataset of data instances;
determine a first subset of the outputs of the first machine learning model and a second subset of outputs of the second machine learning model;
generate a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfies a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfies the first condition;
generate a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition;
train a first classifier based on the first true label matrix;
train a second classifier based on the second true label matrix; and
determine an accuracy of the first machine learning model and an accuracy of the second machine learning model based on the first classifier and the second classifier.

2. The system of claim 1, wherein the first subset of the outputs of the first machine learning model and the second subset of outputs of the second machine learning model have a same number of values.

3. The system of claim 1, wherein when determining the accuracy of the first machine learning model and the accuracy of the second machine learning model, the at least one processor is programmed or configured to:
determine the accuracy of the first machine learning model and the accuracy of the second machine learning model based on a model interpretation technique that is performed on the first classifier and the second classifier.

4. The system of claim 3, wherein the model interpretation technique is a model interpretation technique that involves Shapley additive explanations (SHAP) values.

5. The system of claim 4, wherein when determining the accuracy of the first machine learning model and the accuracy of the second machine learning model, the at least one processor is programmed or configured to:
calculate a SHAP value for each feature value of each data instance of the dataset for the first classifier; and
calculate a SHAP value for each feature value of each data instance of the dataset for the second classifier.

6. The system of claim 5, wherein when determining the accuracy of the first machine learning model and the accuracy of the second machine learning model, the at least one processor is programmed or configured to:
generate a plot of the SHAP value for each feature value of each data instance of the dataset for the first classifier and the SHAP value for each feature value of each data instance of the dataset for the second classifier.

7. The system of claim 5, wherein when determining the accuracy of the first machine learning model and the accuracy of the second machine learning model, the at least one processor is programmed or configured to:
generate a plot of a plurality of SHAP values for a plurality of feature values of a first feature of each data instance of the dataset for the first classifier and a plurality of SHAP values for a plurality of feature values of the first feature of each data instance of the dataset for the second classifier.

8. The system of claim 5, wherein when determining the accuracy of the first machine learning model and the accuracy of the second machine learning model, the at least one processor is programmed or configured to:
calculate an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and
calculate an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier,
wherein the accuracy metric comprises a metric associated with a measure of magnitude of a feature, a metric associated with a measure of consistency of a feature, a metric associated with a measure of contrast of a feature, or a metric associated with a measure of correlation of a feature.

9. A computer-implemented method, comprising:
receiving, with at least one processor, a dataset of data instances, wherein each data instance comprises a feature value for each feature of a plurality of features;
generating, with the at least one processor, outputs of a first machine learning model and outputs of a second machine learning model based on the dataset of data instances;
determining, with the at least one processor, a first subset of the outputs of the first machine learning model and a second subset of outputs of the second machine learning model;
generating, with the at least one processor, a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfies a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfies the first condition;
generating, with the at least one processor, a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition;
training, with the at least one processor, a first classifier based on the first true label matrix;
training, with the at least one processor, a second classifier based on the second true label matrix; and
determining, with the at least one processor, an accuracy of the first machine learning model and an accuracy of the second machine learning model based on the first classifier and the second classifier.

10. The computer-implemented method of claim 9, wherein the first subset of the outputs of the first machine learning model and the second subset of outputs of the second machine learning model have a same number of values.

11. The computer-implemented method of claim 9, wherein determining the accuracy of the first machine learning model and the accuracy of the second machine learning model includes:
determining the accuracy of the first machine learning model and the accuracy of the second machine learning model based on a model interpretation technique that is performed on the first classifier and the second classifier.

12. The computer-implemented method of claim 11, wherein the model interpretation technique is a model interpretation technique that involves Shapley additive explanations (SHAP) values.

13. The computer-implemented method of claim 12, wherein determining the accuracy of the first machine learning model and the accuracy of the second machine learning model includes:
calculating a SHAP value for each feature value of each data instance of the dataset for the first classifier; and
calculating a SHAP value for each feature value of each data instance of the dataset for the second classifier.

14. The computer-implemented method of claim 13, wherein determining the accuracy of the first machine learning model and the accuracy of the second machine learning model includes:
generating a plot of the SHAP value for each feature value of each data instance of the dataset for the first classifier and the SHAP value for each feature value of each data instance of the dataset for the second classifier.

15. The computer-implemented method of claim 13, wherein determining the accuracy of the first machine learning model and the accuracy of the second machine learning model includes:
generating a plot of a plurality of SHAP values for a plurality of feature values of a first feature of each data instance of the dataset for the first classifier and a plurality of SHAP values for a plurality of feature values of the first feature of each data instance of the dataset for the second classifier.

16. The computer-implemented method of claim 13, wherein determining the accuracy of the first machine learning model and the accuracy of the second machine learning model includes:
calculating an accuracy metric value associated with an accuracy metric of a first feature for the first classifier, wherein the accuracy metric value associated with the accuracy metric of the first feature for the first classifier is based on a plurality of SHAP values for a plurality of feature values of the first feature of each data instance of the dataset for the first classifier; and
calculating an accuracy metric value associated with the accuracy metric of the first feature for the second classifier, wherein the accuracy metric value associated with the accuracy metric of the first feature for the second classifier is based on a plurality of SHAP values for a plurality of feature values of the first feature of each data instance of the dataset for the second classifier,
wherein the accuracy metric comprises a metric associated with a measure of magnitude of a feature, a metric associated with a measure of consistency of a feature, a metric associated with a measure of contrast of a feature, or a metric associated with a measure of correlation of a feature.

17. A computer program product comprising at least one non-transitory computer-readable medium including program instructions that, when executed by at least one processor, cause the at least one processor to:
receive a dataset of data instances, wherein each data instance comprises a feature value for each feature of a plurality of features;
generate outputs of a first machine learning model and outputs of a second machine learning model based on the dataset of data instances;
determine a first subset of the outputs of the first machine learning model and a second subset of outputs of the second machine learning model;
generate a disagreement matrix that includes a first set of grouped outputs of the first machine learning model and the second machine learning model and a second set of grouped outputs of the first machine learning model and the second machine learning model, wherein the first set of grouped outputs comprises a plurality of outputs of the first machine learning model that satisfies a first condition and a plurality of outputs of the second machine learning model that does not satisfy the first condition, and wherein the second set of grouped outputs comprises a plurality of outputs of the first machine learning model that does not satisfy the first condition and a plurality of outputs of the second machine learning model that satisfies the first condition;
generate a plurality of true label matrices based on true labels of the first set of grouped outputs and the second set of grouped outputs, wherein a first true label matrix includes true positive outputs of the plurality of outputs of the first machine learning model that satisfy the first condition and true positive outputs of the plurality of outputs of the second machine learning model that satisfy the first condition, and wherein a second true label matrix includes false positive outputs of the plurality of outputs of the first machine learning model that satisfy the first condition and false positive outputs of the plurality of outputs of the second machine learning model that satisfy the first condition;
train a first classifier based on the first true label matrix;
train a second classifier based on the second true label matrix; and
determine an accuracy of the first machine learning model and an accuracy of the second machine learning model based on the first classifier and the second classifier.

18. The computer program product of claim 17, wherein the first subset of the outputs of the first machine learning model and the second subset of outputs of the second machine learning model have a same number of values.

19. The computer program product of claim 17, wherein determining the accuracy of the first machine learning model and the accuracy of the second machine learning model includes:
determining the accuracy of the first machine learning model and the accuracy of the second machine learning model based on a model interpretation technique that is performed on the first classifier and the second classifier,
wherein the model interpretation technique is a model interpretation technique that involves Shapley additive explanations (SHAP) values, and
wherein determining the accuracy of the first machine learning model and the accuracy of the second machine learning model includes:
calculating a SHAP value for each feature value of each data instance of the dataset for the first classifier; and
calculating a SHAP value for each feature value of each data instance of the dataset for the second classifier.

20. The computer program product of claim 19, wherein determining the accuracy of the first machine learning model and the accuracy of the second machine learning model includes:
generating a plot of the SHAP value for each feature value of each data instance of the dataset for the first classifier and the SHAP value for each feature value of each data instance of the dataset for the second classifier.

21.-22. (canceled)
